(19) United States
(12) Patent Application Publication
(10) Pub. No.: US 2006/0023197 A1
(43) Pub. Date: Feb. 2, 2006

(54) Method and system for automated production of autostereoscopic and animated prints and transparencies from digital and non-digital media

(76) Inventor: Andrew H. Joel, Lilburn, GA (US)

Correspondence Address: WOMBLE CARLYLE SANDRIDGE & RICE, PLLC, P.O. BOX 7037, ATLANTA, GA, 30357-0037, US

(21) Appl. No.: 10/899,847

(22) Filed: Jul. 27, 2004

(51) Int. Cl. G03B 35/14

(52) U.S. Cl. 355/77; 355/22

(57) ABSTRACT

A method and system for automated production of stereoscopic and animated images and hardcopies can utilize a light-sensitive lenticular material employing a conventional or non-conventional photographic emulsion or an instant-developing material. An automated printer can produce autostereoscopic and animated hardcopies in multiple formats from digital and non-digital sources, including single images, stereopairs, and multiple-image sets of negatives, transparencies, or prints. The printer, which includes a projection device and a material plate that can rotate around two perpendicular axes, can utilize software to automate viewing angle calculation, printer control, multiple-image alignment, distortion correction, and image processing and conversion. A digital camera can capture stereoscopic and animated images and record them digitally or on photographic film. A non-digital camera can record stereoscopic and animated images directly onto light-sensitive lenticular material employing a conventional or non-conventional photographic emulsion or an instant-developing material. The printer and cameras can utilize autostereoscopic monitors to preview parallax.

### FIELD OF THE INVENTION

The present invention generally relates to digital and non-digital stereoscopic and animated images, and hardcopy prints and transparencies that employ the use of lenticular material.

### BACKGROUND OF THE INVENTION

Some conventional printers for producing autostereoscopic and animated emulsion-coated lenticular hardcopies rely on photographic film to record and subsequently reproduce a series of two-dimensional images. Although the advent of digital cameras, computer graphics workstations, and 3D imaging software coupled with CRT monitors and digital projection devices have enabled the development of digital emulsion-coated lenticular imaging systems, these systems can print effectively only from digital sources.

During the 165-year lifetime of stereoscopic photography, a wealth of non-digital stereoscopic image content has been created, including more than one billion stereopair images and millions of multiple-image negative sets generated by consumer 3D cameras, of which none can be directly printed by existing digital printing systems. Even when printing directly from digital media with existing digital printing systems, the process required to produce the first lenticular hardcopy from a 3D dataset or a series of photographic images is complicated, time-consuming, can be executed well only by an expert in the field, and does not yield consistent results. Further, although existing emulsion-coated lenticular digital imaging systems can be configured to produce hardcopies with either a horizontal or a vertical format at a system's maximum pixel resolution, any single configuration in an existing system cannot produce both horizontal and vertical formats at full resolution. The restricted production capabilities of existing systems effectively diminish the potential for commercial exploitation.

It is therefore desirable to provide the components of an automated system that can efficiently and consistently produce high-quality autostereoscopic and animated lenticular hardcopies, formatted both vertically and horizontally at full resolution, from both digital and non-digital media, on-demand. It is also desirable to provide an automated system that can print directly from a large number of possible image media and sources in order to take advantage of economies of scale to lower the system's production costs for lenticular consumable materials.

Both the method and system of the present invention are hardware-optimized and software-optimized to efficiently produce single copies or volume quantities of photographic-quality autostereoscopic and animated hardcopies from digital and non-digital sources, and from any negative or positive single-image or conventional multiple-image format, including film from 3D consumer cameras and stereopairs (e.g., View-Master® reels). The present invention can also utilize printer-based and camera-based instant-developing light-sensitive lenticular material to produce photographic-quality autostereoscopic and animated lenticular hardcopies, thus obviating the need for conventional photo-processing that typically is associated with photographic-quality lenticular imaging systems.

### SUMMARY OF THE INVENTION

The present invention generally includes printer technology, camera technology, and light-sensitive lenticular material technology. The light-sensitive lenticular material, which can be printer-based or camera-based, generally includes a layer of lenticular material and a layer of light-sensitive material, which can be instant-developing, and can include a separate adhesive layer. An automated printer utilizing light-sensitive lenticular material can import content from both digital and non-digital (i.e., from negatives, transparencies or prints) media, to produce hardcopy prints and transparencies that appear autostereoscopic or animated. The printer, which can correct for keystone distortion and can utilize Scheimpflug correction, includes an exposure device and a material plate, with the material plate capable of rotation around two perpendicular axes. The printer can utilize software to control the printer's mechanical functions, to conduct various image-processing and image-alignment routines to manipulate and optimize the printer's hardcopy output, to calculate viewing angles for printing from three-dimensional datasets, and to convert two-dimensional or stereopair image data into three-dimensional image sets for the printing of autostereoscopic hardcopies. A camera that can capture and record images in a digital or non-digital medium can capture images from multiple viewpoints without repositioning and can record images digitally or directly onto negatives or camera-based light-sensitive lenticular material.

These and other aspects of the present invention are set forth in greater detail below and in the drawings, which are briefly described as follows.

### BRIEF DESCRIPTION OF THE DRAWINGS

In the drawings, like reference characters designate the same or similar parts throughout the figures.

FIG. 1A to FIG. 1C show three embodiments of light-sensitive lenticular material.

FIG. 2A to FIG. 2C show three embodiments of light-sensitive parallax barrier strip material.

FIG. 3 shows an embodiment of instant-developing light-sensitive lenticular material.

FIG. 4 shows a person's perspective of exposed and processed instant-developing light-sensitive lenticular material viewing a pair of image bands beneath a lenticule.

FIG. 5 shows a series of two-dimensional images representing a sequence of events at different moments in time.

FIG. 6 shows a series of two-dimensional images representing a group of images of a three-dimensional scene.

FIG. 7 shows pairs of individual images in a series from different viewpoints of a three-dimensional scene used in stereopairs to form a three-dimensional representation of the scene.

FIG. 8 shows an image band created under each lenticule of a lenticular layer by exposing instant-developing light-sensitive material through the lenticular layer from a particular projection angle.

FIG. 9 shows a series of distinct image bands created under each lenticule of a lenticular layer by exposing instant-developing light-sensitive material through the lenticular layer at different projection angles.

FIG. 10 shows a printer whereby the material plate rotates around a vertical axis.

FIG. 11A to FIG. 11C show a printer with the light-sensitive material of the printer-based light-sensitive lenticular material exposed from different projection angles by rotating the material plate.

FIG. 12A to FIG. 12C show keystone distortion of images exposed onto printer-based light-sensitive lenticular material from different projection angles.

FIG. 13 shows pre-distortion of images exposed onto printer-based light-sensitive lenticular material from different projection angles to create images that appear undistorted.

FIG. 14 shows a printer with the material plate rotational about two perpendicular axes.

FIG. 15 shows lenticules on different hardcopy images oriented in relation to a captured scene, both during exposure by the printer and when the hardcopy is viewed, with the material plate rotational only about a single axis and the exposure device permanently mounted in an orientation perpendicular to the axis of rotation.

FIG. 16 shows lenticules on different hardcopy images oriented in relation to a captured scene, both during exposure by the printer and when the hardcopy is viewed, with the material plate rotational about two perpendicular axes and the exposure device permanently mounted in a fixed orientation.

FIG. 17 shows a printer utilizing built-in manual or automatic Scheimpflug correction.

FIG. 18 shows an image processing technique that can be utilized by the printer where a 3D mask can be created to allow insertion of digital content into the image composition.

FIG. 19 shows an example personalized secure ID card created by the image processing software of the printer.

FIG. 20A to FIG. 20H show selection of a key subject to align a series of images for printing an autostereoscopic or non-stereoscopic hardcopy.

FIG. 21A to FIG. 21C show the printer's alignment software process of setting the perceived depth location of the key subject or reference plane, in order to create different autostereoscopic hardcopies.

FIG. 22A and FIG. 22B show a printer capable of producing auto-stereoscopic and animated hardcopies from both digital and non-digital media.

FIG. 22C shows five examples of masks that can be utilized with the printer shown in FIG. 22A or 22B for electronic image capture of non-digital media.

FIG. 23A shows a printer capable of performing an image-developing process, where a photo-processor is contained within the printer.

FIG. 23B shows a printer capable of performing an image-developing process, where a photo-processor is not contained within the printer.

FIG. 24A and FIG. 24B show a parallax-adjustable multiple-lens multiple-sensor digital camera.

FIG. 25A and FIG. 25B show a parallax-adjustable multiple-lens single-sensor digital camera.

FIG. 26 shows an alternate embodiment of a parallax-adjustable multiple-lens single-sensor digital camera.

FIG. 27 shows an alternate embodiment of a parallax-adjustable multiple-lens single-sensor digital camera, where one or more mirrors can fold the exposure light path.

FIG. 28A and FIG. 28B show another embodiment of a parallax-adjustable single-lens single-sensor digital camera.

FIG. 29 shows another embodiment of a multiple-lens non-digital camera.

FIG. 30 shows a multiple-lens non-digital camera, where an odd number of mirrors are utilized to fold each exposure light path.

FIG. 31 shows another embodiment of a multiple-lens non-digital camera, where an odd number of mirrors are utilized to fold each exposure light path.

FIG. 32 shows system components and example market applications related to the production and delivery of autostereoscopic and animated hardcopy prints and transparencies produced from digital and non-digital media.

FIG. 33 shows a method of producing a hardcopy image.

### DETAILED DESCRIPTION OF THE INVENTION

Since a two-dimensional (2D) object or scene is restricted to a single plane its location can be described completely with only two orthogonal axes. Accordingly, a two-dimensional image appears flat and exhibits no depth or volume. In contrast, since a three-dimensional (3D) object or scene is not planar and has volume, it can be represented only partially by a single two-dimensional image. The perspective of a 3D object or scene as viewed from one's left eye will be different from the perspective viewed at the same time from the right eye, and this apparent difference is an example of binocular parallax. The simultaneous viewing of these right-eye and left-eye perspectives produces a retinal disparity that provides for stereoscopic viewing of a 3D object or scene. The two separate perspective images are known collectively as a stereopair, and the simultaneous viewing of a stereopair by one's right and left eye creates a perception of depth of a three-dimensional image. While some stereoscopic images require the use of special glasses or other viewing aids, in order to achieve the perception of depth, autostereoscopic images are stereoscopic images that can be viewed stereoscopically without a viewing aid. Additionally, analogous to the animation effect exhibited by a series of two or more two-dimensional images viewed in succession, an animation effect also can be achieved with a series of two or more three-dimensional images, whereby the result generally will be stereoscopic animation.

As used in this document, each of the following words shall be defined by its respective ensuing definition:
medium: a means or instrumentality for storing or communicating information;
media: a plural form of the word “medium”;
source: that from which something comes forth, regarded as its cause or origin;
content: subject matter;
turret: any device holding various lenses that allows switching from one lens to another.

Further, in this document when the term “including” is used and is followed by one or more illustrative examples, the ensuing list of examples is not inclusive and can include similar items that are not specifically listed.

Light-Sensitive Lenticular Material

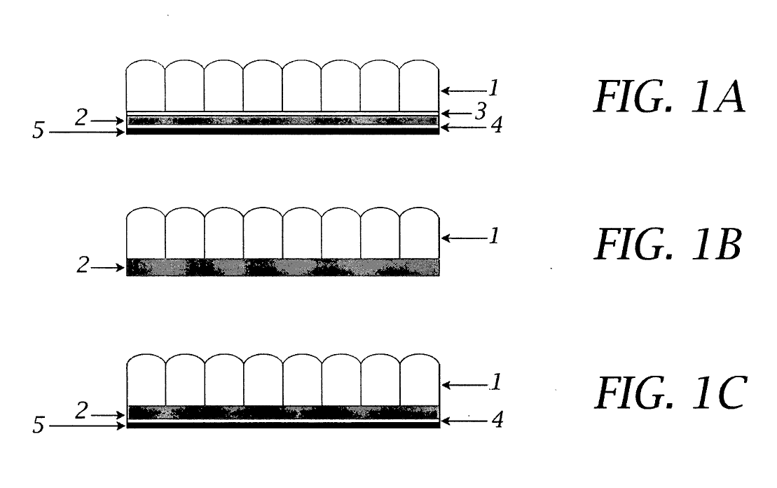

FIG. 1A to FIG. 1C show three embodiments of light-sensitive lenticular material. The light-sensitive lenticular material is exposed by light and processed to create a hardcopy print or transparency of one or more images.

FIG. 1A shows a light-sensitive lenticular material that includes a lenticular layer (1) and a layer of light-sensitive material (2). The lenticular layer (1) can be permanently attached or impermanently attached to the layer of light-sensitive material (2) to form the light-sensitive lenticular material. In lieu of direct attachment of the lenticular layer (1) to the light-sensitive material (2), an adhesive layer (3) can be included between the lenticular layer (1) and light-sensitive material (2). The light-sensitive lenticular material optionally can include an anti-halation layer (4), which can prevent unintended exposure of the light-sensitive material caused by the spread or scattering of light within the light-sensitive material or by light reflected from the base. An optional opaque layer (5) of dye or other substance, such as titanium oxide, can be utilized on the back surface of the light-sensitive lenticular material, opposite the surface of light-sensitive material (2) that faces the lenticular layer (1), which blocks light and provides an opaque layer on the back of the light-sensitive lenticular material for the production of hardcopies viewable as reflective prints. Without the optional opaque layer (5), the hardcopies can be viewed as transparencies. Light from a scene passes through the lenticular layer (1) onto the layer of light-sensitive material (2), exposing the light-sensitive material, and creating a hardcopy of an image.

FIG. 1B shows the light-sensitive lenticular material as a two-part material that includes a lenticular layer (1) and light-sensitive material (2). The light-sensitive material (2) of this exemplary embodiment also has adhesive properties, with a separate adhesive layer being unnecessary. The light-sensitive material (2) attaches directly to the lenticular layer (1). This embodiment can allow for simplified manufacturing, decreased costs, and minimal optical distortion compared to light-sensitive lenticular material with the separate adhesive layer.

FIG. 1C shows an alternate embodiment of the light-sensitive lenticular material shown in FIG. 1B that includes an optional anti-halation layer (4) and an optional opaque layer (5).

The light-sensitive lenticular material can be adapted for use with many different applications. For example, if the light-sensitive lenticular material is to be used in a camera, the composition of the layer of light-sensitive material (2) can be adapted to the intensity, duration and quality of light that typically passes through the camera lens to expose the light-sensitive material (2). Additionally, the light-sensitive lenticular material can be further optimized as camera-based light-sensitive lenticular material. If the light-sensitive lenticular material is to be used in a printer, the composition of the layer of light-sensitive material (2) can be adapted to the intensity, duration and quality of light typically projected from a printer's exposure device to expose the light-sensitive material (2). Additionally, the light-sensitive lenticular material can be further optimized as printer-based light-sensitive lenticular material.

The light-sensitive lenticular material detailed herein can be used for many purposes. For example, the light-sensitive lenticular material can be used for creating autostereoscopic hardcopies that appear three-dimensional. Alternatively, the light-sensitive lenticular material can be used for creating non-stereoscopic hardcopies, such as a hardcopy that exhibits a single two-dimensional image or a hardcopy that exhibits an animation effect (i.e., sequence of two or more images). The light-sensitive lenticular material also can be used for creating autostereoscopic hardcopies that appear three-dimensional and also exhibit an animation effect.

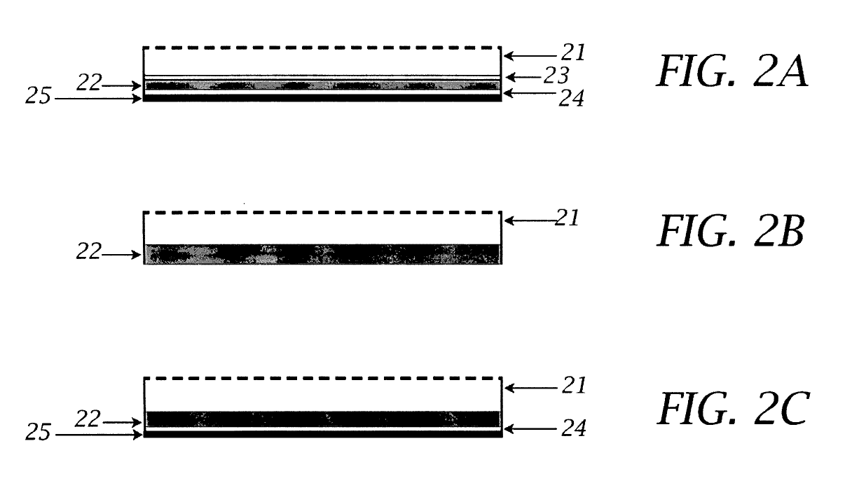

The lenticular layer (1) includes one or more lenticules that can be any shape or size that allows light to pass through the lenticular layer (1) onto the light-sensitive material (2). The lenticules can have a triangle-like cross section or a semicircle-like or spherical cross section. Alternatively, a layer of parallax barrier strip material can be used in place of the lenticular layer, in combination with a light-sensitive material to record one or more images. One example of a parallax barrier strip material is an opaque material that has transparent sections spaced at regular intervals and where the left and right eye can each see only its corresponding image through the transparent sections, since each eye's non-viewable image area is blocked by opaque sections of the material. FIG. 2A shows an embodiment of a light-sensitive parallax barrier strip material that includes a layer of parallax barrier strip material (21), a layer of light-sensitive material (22), an adhesive layer (23), an optional anti-halation layer (24), and an optional opaque layer (25). FIG. 2B shows an alternate embodiment of a light-sensitive parallax barrier strip material that includes a layer of parallax barrier strip material (21) and a layer of light-sensitive material (22) with adhesive properties. FIG. 2C shows another embodiment of a light-sensitive parallax barrier strip material with an optional anti-halation layer (4) and an optional opaque layer (5) included.

The light-sensitive material can be sensitive to light that is visible to the human eye, as well as to light that is not visible to the human eye (i.e., non-visible light). Non-visible light includes electromagnetic radiation in wavelengths that are outside the range of visible light, such as infrared light, ultra-violet light, gamma rays, all types of x-rays (including synchrotron x-rays), radio waves, and microwaves (including different types of radar).

Different types of light-sensitive material can be utilized in order to control the spectral sensitivity of the layer of light-sensitive material in the light-sensitive lenticular material, and thus the effective spectral sensitivity of the light-sensitive lenticular material itself. For example, a silver halide-based photographic emulsion can be used to make the layer of light-sensitive material sensitive only to the ultraviolet, violet, and blue wavelengths in the visible and near-visible spectrum, and additional sensitizing dyes can be used in the layer of light-sensitive material to extend the sensitivity to the green, red, and near-infrared portions of the spectrum. In an alternate embodiment, a layer of light-sensitive material, sensitive only to certain wavelengths of infrared light, can be used. This technique can be particularly effective for applications utilizing camera-based light-sensitive lenticular material, with or without the use of additional filters, for aerial, security, military, medical, or other specialized photographic applications. Any type of available light-sensitive material can be included in the layer of light-sensitive material as a component of the light-sensitive lenticular material, including infrared-sensitive, x-ray-sensitive, ultraviolet-sensitive, radio-wave-sensitive, microwave-sensitive, and gamma-ray-sensitive materials.

The layer of light-sensitive material can include film-based or paper-based light-sensitive material, and can utilize conventional negative-based or positive-based emulsions. For example, emulsions utilizing RA4, C41, E6, EP2, Cibachrome, or black-and-white film or paper photochemistry processes can be used wherein the emulsion is exposed by light which passes through the lenticular layer and the emulsion is subsequently processed with chemicals to create an image. This processing can be accomplished by various conventional methods. For example, the processing can occur manually in trays, in drums (manually or with rollers), with a tabletop photo-processing system (such as the Nova slot print processor), or with a roller-transport system to move the exposed light-sensitive lenticular material through the appropriate photochemical processing solutions that are contained in photo-processing tanks.

The layer of light-sensitive material can also include non-conventional photographic emulsion materials. One example of this type of material is a light-sensitive material that utilizes the Fujifilm Pictrography® thermal development and transfer system that requires no chemicals or toners in the development process, and that utilizes a laser diode for exposure of a digital image.

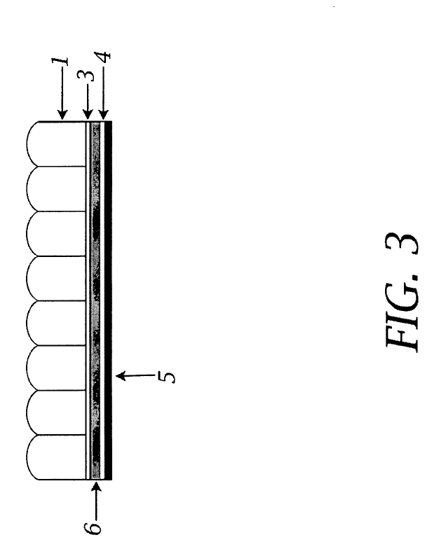

The light-sensitive lenticular material can utilize an emulsion that employs an “instant” developing light-sensitive material. Examples of this type of light-sensitive material are used in various Polaroid processes. FIG. 3 shows one exemplary embodiment of instant-developing light-sensitive lenticular material. An instant-developing light-sensitive material (6) records an image from light that passes through the lenticular layer (1). The instant-developing light-sensitive lenticular material can also include an adhesive layer (3) between the lenticular layer (1) and the instant-developing light-sensitive material (6). Alternatively, the instant-developing light-sensitive material (6) can have adhesive properties. Further, the instant-developing light-sensitive lenticular material can include an anti-halation layer (4) or an optional opaque layer (5) of a substance such as a dye or titanium oxide. The optional opaque layer (5) can be utilized on the back surface of the light-sensitive lenticular material, opposite the surface of instant-developing light-sensitive material (6) that faces the lenticular layer (1).

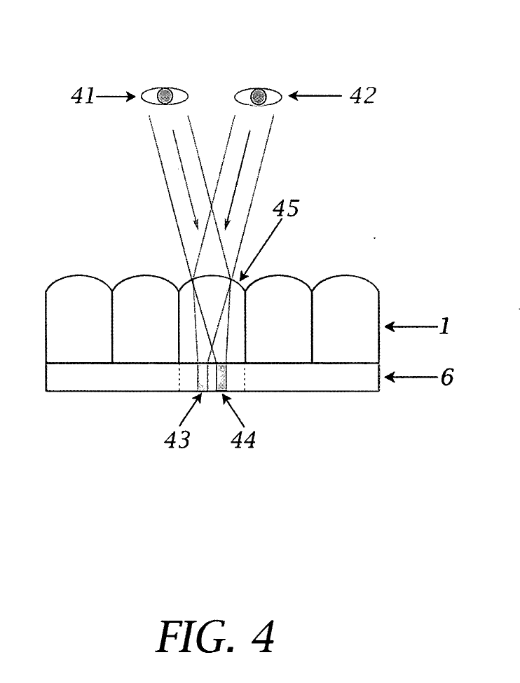

FIG. 4 shows the instant-developing light-sensitive lenticular material that has been exposed and processed to record a hardcopy image. Each eye (41 and 42) of a viewer sees through each lenticule (45) only the image bands (43 and 44) that have been exposed from a specific projection angle. The viewer can simultaneously view two different images (i.e., a stereopair) that have been recorded in the instant-developing light-sensitive material (6) from two different viewing angles. The viewer views both images as a single three-dimensional image.

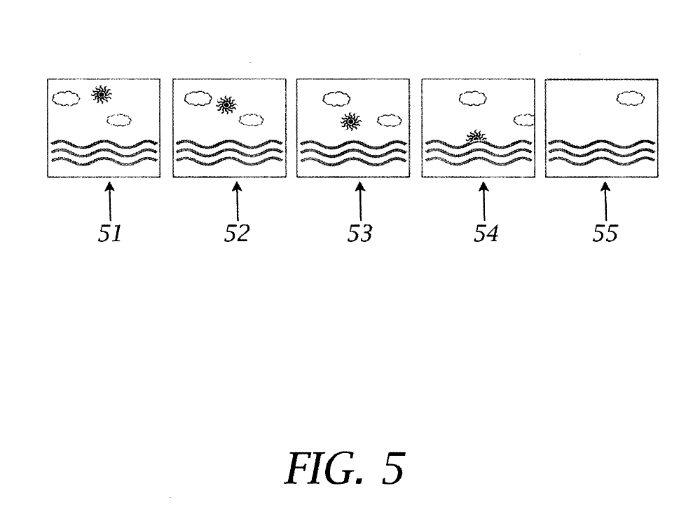

FIG. 5 shows a series of two-dimensional images (51-55) that represents a sequence of events at different moments in time and that shows one image changing or morphing into a different image (representing a similar scene or environment). Image bands that correspond to each of these images (51-55) are recorded on the light-sensitive material through the lenticular layer. The image bands on the resulting hardcopy (i.e., exposed and processed light-sensitive lenticular material) are viewed through the lenticular layer. Further, the hardcopy can be tilted or rotated, or the position of a viewer's eyes can change in relation to the hardcopy, in order to view the series of images (51-55) as a moving animation of two-dimensional images.

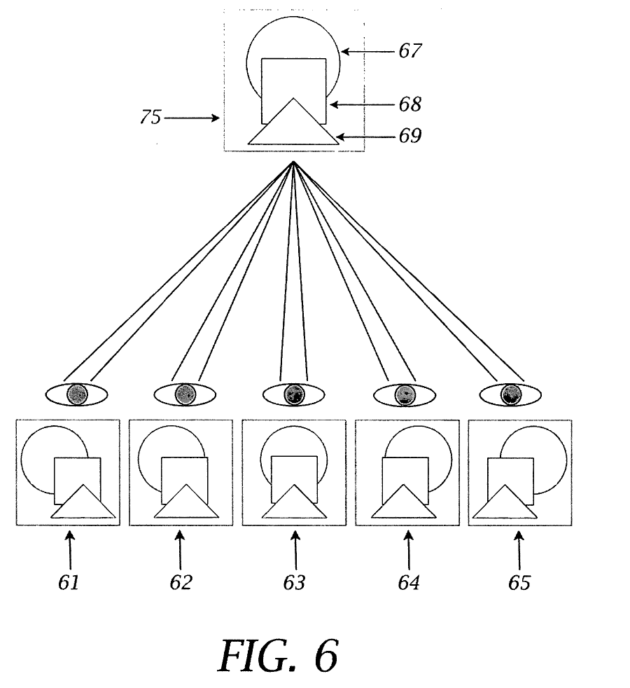

FIG. 6 shows a series of two-dimensional images (61-65) that represents a group of images captured of a stationary three-dimensional scene (75), and where each image in the series is captured from a different viewpoint of the three-dimensional scene. Image bands that correspond to each of these images (61-65) are recorded on the light-sensitive material through the lenticular layer. The image bands on the resulting hardcopy can be viewed through the lenticular layer as an autostereoscopic image.

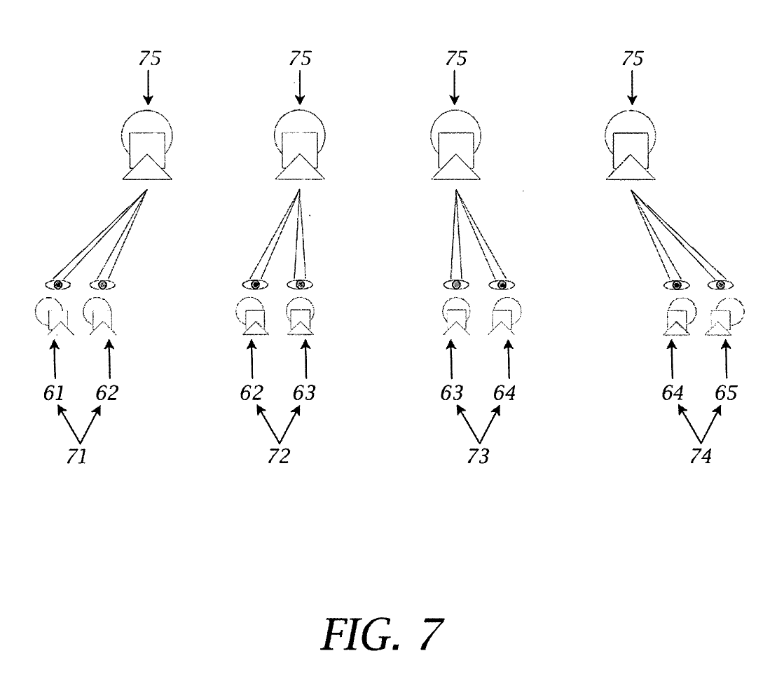

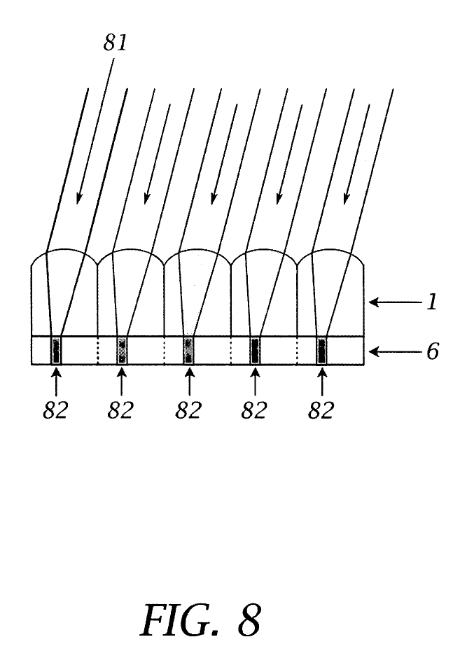

FIG. 7 shows pairs of individual images (71-74) from a series of images (61-65) captured from different viewpoints of a three-dimensional scene (75) used as a stereopair to form a three-dimensional representation of the scene. Within the series of images (61-65), a combination of any two distinct images from the series of images (61-65) can represent a stereopair of the three-dimensional scene (75), with each distinct stereopair representing a different stereoscopic view of the three-dimensional scene (75).

Printer

A printer can utilize several embodiments of the printer-based light-sensitive lenticular material or printer-based light-sensitive parallax barrier strip material to produce autostereoscopic and non-stereoscopic hardcopies, in both vertical (portrait) and horizontal (landscape) formats. The printer can produce hardcopies of a single image, of a series of temporally differentiated, morphed or otherwise animated images, or from different views of a real or synthesized three-dimensional object or scene. The printer can produce hardcopies from several different sources of image content, including from digital media (data), multiple-image negative film strips (including stereopair formats), multiple-image transparency film strips (including stereopair formats), multiple-image prints (including stereopair formats), and/or single images in a digital, negative, transparency, or print format.

As shown in FIG. 8, a hardcopy of an image is created by exposing instant-developing light-sensitive material (6) to light (81) from a particular exposure angle through the lenticular layer (1). A corresponding section of instant-developing light-sensitive material under each lenticule is exposed, thereby creating an image band (82) under each lenticule. After exposure and instant processing of the instant-developing light-sensitive material (6), when the instant-developing light-sensitive material (6) is viewed through the lenticular layer (1) at the same angle as the exposure angle, each of the image bands (82) is viewed through its corresponding lenticule. Then, the image bands collectively can be seen as a single complete image.

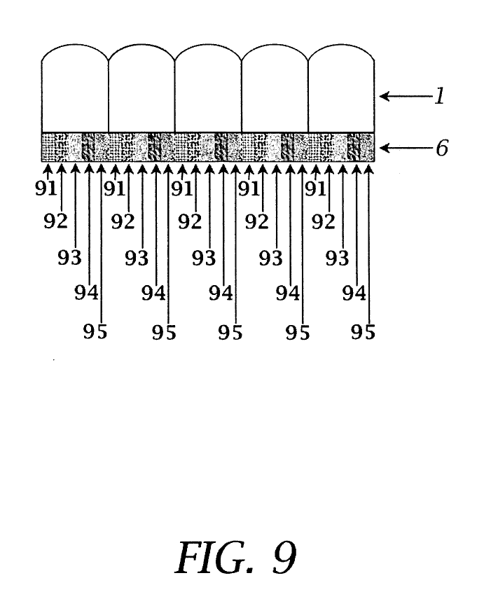

In one embodiment, the instant-developing light-sensitive material is exposed to light projected at different angles, with each angle corresponding to a different image. In this embodiment, each image represents a different perspective of a three-dimensional object or scene. As shown in FIG. 9, when the instant-developing light-sensitive material (6) is exposed through the lenticular layer (1) at different projection angles, a series of distinct image bands (91-95) can be created side-by-side, and these bands (91-95) can fill the space underneath each lenticule. After the instant-developing light-sensitive material is processed, the image bands (91-95) can be seen through the lenticular layer of the resulting hardcopy as complete three-dimensional images.

The printer can employ virtually any projection display device to project images onto the printer-based light-sensitive lenticular material. The projection device can utilize various display technologies including liquid crystal display (LCD), liquid crystal on silicon (LCOS), direct drive image light amplifier (DILA), light emitting diode (LED), organic light emitting diode (OLED), polymer light emitting diode (PLED), field emission display (FED), digital light processing (DLP), plasma display panel (PDP), holographic optical elements (HOE), surface-conduction electron-emitter (SED), nematic curvilinear aligned phase (NCAP), organic electroluminescent (Organic EL), fiber optics, various types of lasers, and digital or non-digital matrix-based or non-matrix-based projection display technology. The printer can also employ an analog display device, such as a cathode ray tube (CRT) based projection device.

The printer's projection device can utilize a lens with a fixed focal length, or it can utilize a zoom lens to increase or decrease the magnification of the projected image. A zoom lens can allow multiple sizes of light-sensitive lenticular material to be exposed for the production of different hardcopy sizes, without changing lenses. Alternatively, the projection device can utilize a turret or other rotating or movable multiple-lens holder to position one of two or more different lenses between the projection device and the material plate.

For printer embodiments using a projection device that employs display technology requiring an illumination source, such as DLP, LCD, LCOS, and DILA, the projection device can utilize multiple lamps or lamp housings, where one or more backup lamps can illuminate if a primary lamp burns out or otherwise fails. The use of multiple illumination sources can allow a printing session to continue uninterrupted in the event of a lamp failure.

In another embodiment of the printer, an image is projected through a projection lens onto printer-based light-sensitive lenticular material, which is positioned on a flat material plate. The light path of the projected image can follow a straight line between the projection source and the light-sensitive lenticular material or, alternatively, the projected image can utilize one or more mirrors to fold the light path between the projection source and the light-sensitive lenticular material. The image can be projected as a single full-color image or, alternatively, the image can be separated into distinct components and projected onto the printer-based light-sensitive lenticular material as a series of separate components. Further, a full-color image can be separated into red, green, and blue elements or, alternatively, into cyan, magenta, and yellow elements, and exposed as three different color-separated images. Here, each color-separated image represents the individual red-green-blue or cyan-magenta-yellow component of the full-color image. This ability to separate the color elements of an image can be used to control the color balance of the final hardcopy image in situations in which a particular light-sensitive material reacts differently to different colors, by controlling the amount of exposure of each particular color.

In another embodiment, an image can be projected as three different color-separated black-and-white (i.e., grayscale) images, with each of the black-and-white images representing the respective density of red, green, or blue or, alternatively, of cyan, magenta, or yellow in the color image. A red-green-blue or cyan-magenta-yellow color filter wheel can be utilized between the projection (i.e., exposure) source and the printer-based light-sensitive lenticular material to provide the desired exposure for each of the primary additive (red-green-blue) or subtractive (cyan-yellow-magenta) colors. Alternatively, a color filter wheel comprising red, green, blue, cyan, magenta, and yellow filters can be utilized, so that both additive and subtractive color filtration can be accomplished with the same filter wheel. One example of a color filter wheel is a round or other-shaped object containing separate color filters, which can rotate to move a specific color filter into position for filtering a particular color light in a projected image. Also, the projected images can be positive or negative imagery, correlating with the type of emulsion or recording medium (positive or negative) used as the light-sensitive material.

Additionally, one or more neutral-density filters can be positioned between the exposure device and the material plate and can be held in place by a filter wheel or other filter-holding device. If an increase in exposure time is desired, the use of neutral-density filtration can reduce the intensity (i.e., brightness) of projected light exposing the light-sensitive lenticular material on the material plate. For example, if a given exposure time for light projected onto light-sensitive lenticular material is too short to fall within the desired exposure time range for the light-sensitive material layer, reciprocity failure can result, causing color shifts and/or other exposure anomalies. With the use of one or more neutral-density filters, an exposure time can be increased by a factor corresponding to the decrease in intensity of the exposed light effected by the neutral density filtration. One or more neutral density filters can be used in combination with a color filter wheel or, alternatively, neutral density filtration can be used in the absence of other filtration between the projection source and the material plate.

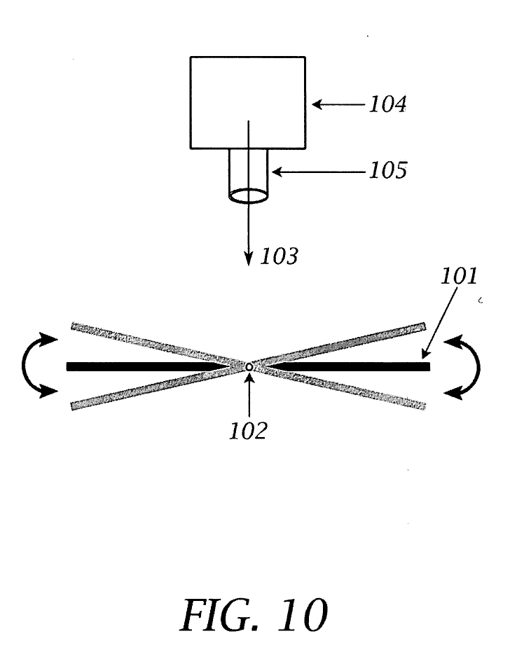

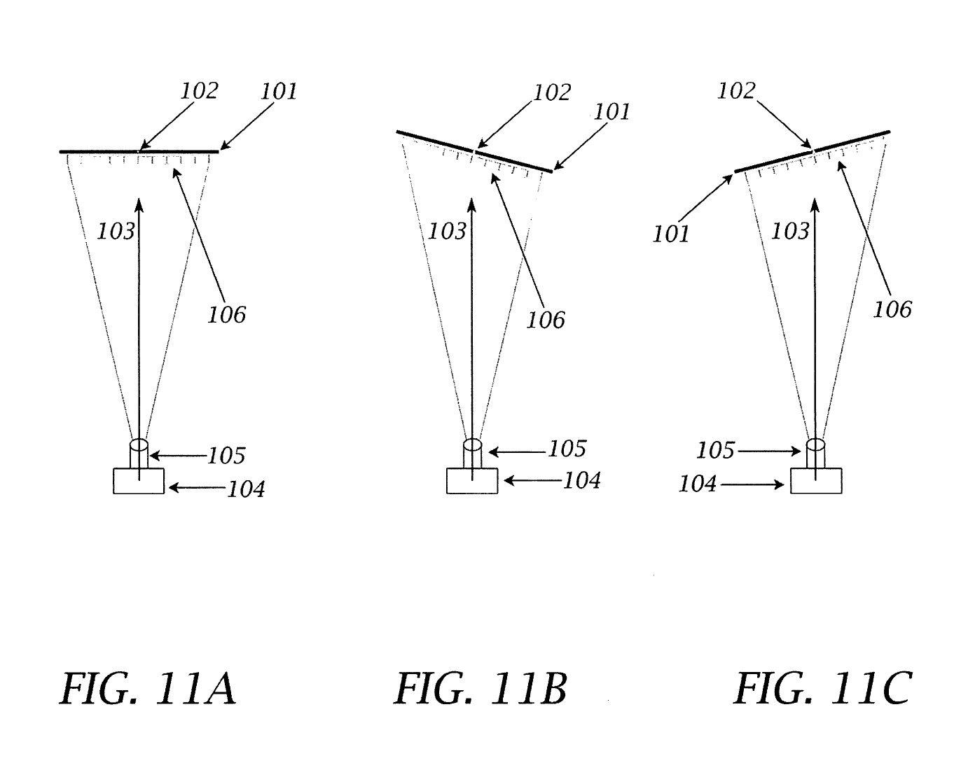

FIG. 10 and FIG. 11A to FIG. 11C show a printer with a material plate (101), which holds a sheet or section of light-sensitive lenticular material flat with a vacuum or mechanical easel. The material plate rotates at its horizontal (lateral) midpoint (102) around a vertical axis that is perpendicular to the projection path (103) and that extends from the center of an imaging device (104) through the center of the projection lens (105). In the plate's center position shown in FIG. 11A, the material plate (101) is parallel to the plane of the imaging device (104). One or more images can be projected through the lenticular layer of the printer-based light-sensitive lenticular material (106) on the material plate (101). The light-sensitive material of the printer-based light-sensitive lenticular material (106) can be exposed from different projection angles by rotating the material plate (101) as shown in FIG. 11A to FIG. 11C, with each projection (i.e., exposure) angle determined by the amount of material plate rotation in relation to the projection path (103).

In one embodiment of the printer, printer-based light-sensitive lenticular material can be loaded into the printer as pre-cut sheets. Here, individual sheets are moved onto the material plate and exposed at a single or at multiple angles. In another embodiment, printer-based light-sensitive lenticular material can either be loaded into the printer as a roll with single sheets cut from the roll inside the printer prior to exposure or single sheets can be cut from the roll inside the printer after that section of light-sensitive lenticular material has been exposed one or more times. Alternatively, the roll is advanced after a section of the light-sensitive lenticular material is exposed one or more times to allow an unexposed section of the light-sensitive lenticular material to be moved into position for exposure. The present printer can be loaded with multiple types of light-sensitive lenticular material simultaneously, in sheet-form or in roll-form, to facilitate the production of hardcopies from more than one type of material without unloading or re-loading sheets or rolls of material. Alternatively, the present printer can be loaded with light-sensitive lenticular material in both sheet-form and roll-form, simultaneously.

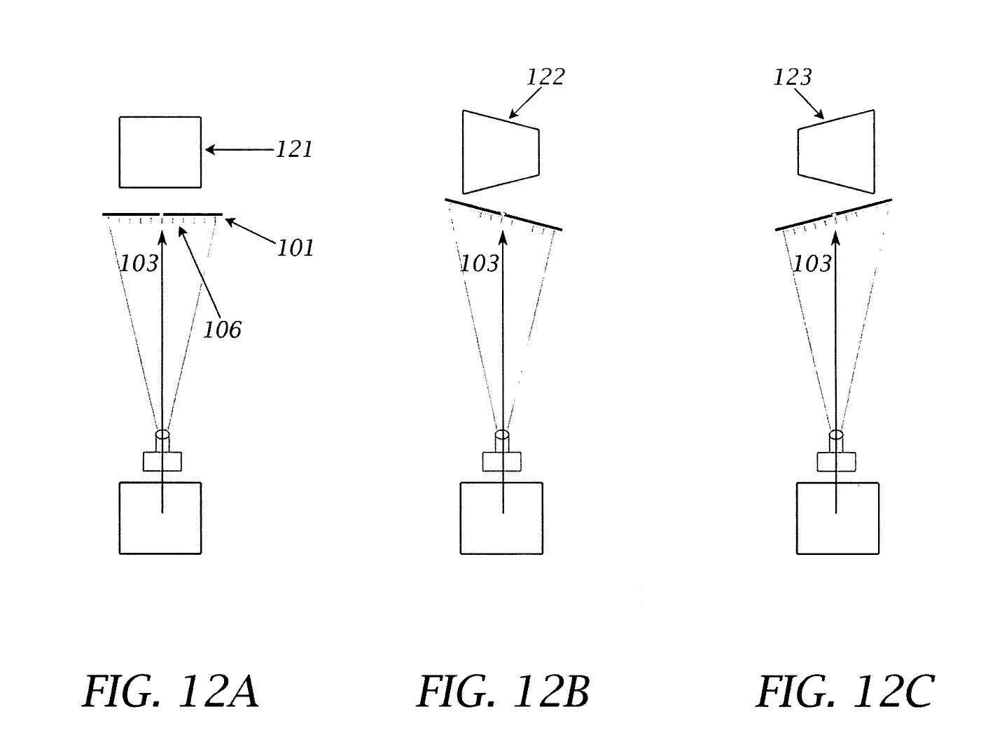

FIG. 12A to FIG. 12C show what is known as “keystone distortion.” If the material plate (101) is rotated as described above, the resulting images (121-123) that are projected onto the printer-based light-sensitive lenticular material (106) can be distorted because the images are exposed at different projection angles. The amount of distortion generally is proportional to the severity of the angle at which the material plate (101) is rotated relative to the projection path (103). If an image is exposed onto the printer-based light-sensitive lenticular material (106) when the material plate is in its center position as shown in FIG. 12A, the corresponding image (121) could be formed without distortion. However, if the material plate is rotated as shown in FIG. 12B or FIG. 12C, the resulting images can be trapezoidal (122 and 123) due to keystone distortion.

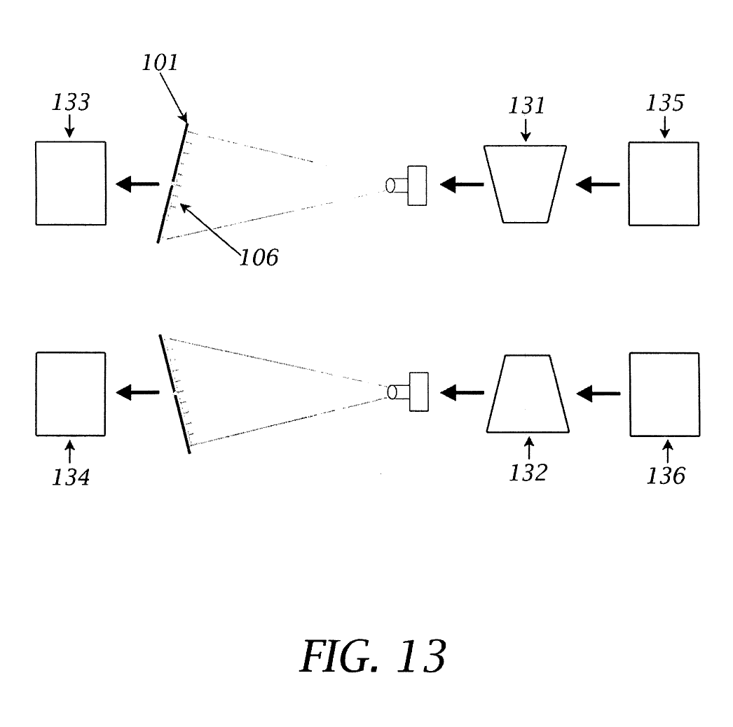

FIG. 13 shows the printer with images (135 and 136), which normally would be distorted, corrected before the light-sensitive lenticular material (6) is exposed and a hardcopy is created. In order to correct the image distortion, each of the images (135 and 136) is pre-distorted (131 and 132) with image processing software included as a component of the printer's control-and-operation software. The amount of pre-distortion generally is proportional to the amount that each particular image is distorted when projected onto the printer-based light-sensitive lenticular material (106) that is positioned on the material plate (101). Therefore, the pre-distorted (i.e., keytone-corrected) images appear rectangular (133 and 134) on the printer-based light-sensitive lenticular material (106), and thus not trapezoidal, regardless of the severity of the projection angle. As previously stated, the printer's control-and-operation software can include algorithms to correct keystone distortion by automatically pre-distorting the images. For severe projection angles, images can also be pre-distorted in an amount proportional to the severity of the angle to correct for anamorphic distortion. The degree of material plate rotation can occur at a finite number of predetermined intervals, which correspond to specific projection angles to make the corresponding amounts of pre-distortion finite. This would simplify the image distortion correction process by limiting the number of possibilities for projection angles and pre-distortion amounts. The printer's control-and-operation software can operate from a computer embedded in the printer itself or, alternatively, can operate from a computer external to, but connected to, the printer. The software includes program components capable of controlling and operating the printer.

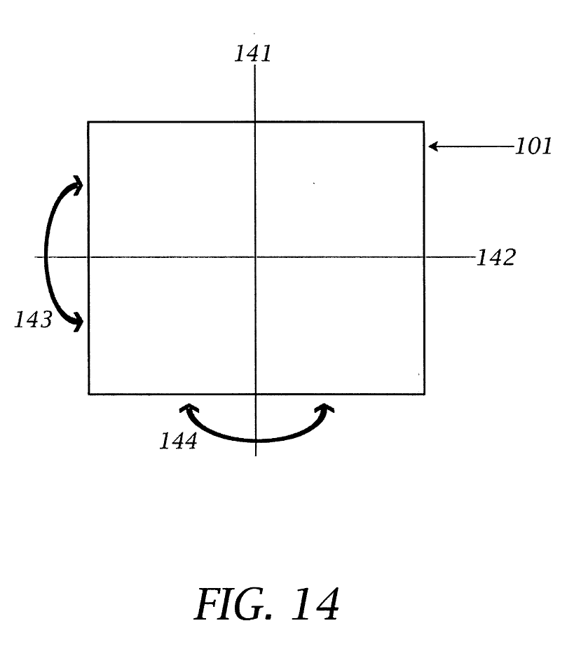

FIG. 14 shows the printer with the material plate (101) capable of rotating around, or rotational around or about, an axis (141) perpendicular to the primary axis (142), to allow “up-and-down” rotation (143) and “side-to-side” rotation (144). The ability of the material plate (101) to move around the two axes (141 and 142) increases the versatility of the printer, compared to a printer with a material plate rotational around only a single axis. Rotation around two perpendicular axes allows production of both horizontally-formatted (landscape format) and vertically-formatted (portrait format) autostereoscopic and non-stereoscopic hardcopies, while utilizing the full resolution capability of the projection (i.e., exposure) device employed by the printer. Because the material plate can rotate around both perpendicular axes, it can also be positioned obliquely relative to its center position, rather than being positioned with regard to only one or the other of the two axes. This ability of the material plate to move obliquely allows the present printer to produce lenticular hardcopies employing diagonally-oriented rows of lenticules. The material plate can rotate between individual exposures, during individual exposures, or both between and during individual exposures. Rotation of the material plate around one or both axes during exposure can be used to more completely fill up the space underneath each lenticule so that there is no unexposed area between separate exposed image bands, or it can be used to overlap exposed areas of bordering image bands. This during-exposure rotation can be used when the number of individual images exposed is less than the optimal number of exposures as determined by the optical and material characteristics of the lenticular layer of the light-sensitive lenticular material. The use of during-exposure rotation of the material plate around both axes for oblique movement can be used to more completely expose or fill the space under each lenticule when diagonally-configured lenticular materials are used or to create special effects with both lenticular and non-lenticular printing materials.

Alternatively, the material plate itself could be formed to rotate around only one axis at one time and the entire material plate assembly could rotate 90 degrees clockwise or counter-clockwise around the axis of the exposure path to change the orientation of the primary axis of rotation of the material plate, and, thus, the light-sensitive lenticular material, by 90 degrees. Here, the material plate is positioned in one orientation to produce horizontal autostereoscopic hardcopies, for example, and can be rotated 90 degrees from its initial position to a second orientation to produce vertical autostereoscopic hardcopies. While this configuration can lower the versatility of the material plate in comparison to the configuration allowing rotation of the material plate around both axes from a single orientation, the simplified movements of this alternate embodiment can reduce the complexity and cost of the material plate and plate rotation assembly.

An alternative embodiment of the printer that accomplishes the production of multiple autostereoscopic and non-stereoscopic hardcopy formats (i.e., both horizontal and vertical) at maximum pixel resolution utilizes a square material plate with a square-formatted imaging panel (such as DLP, LCD, LCOS, DILA, or the like) or display (such as CRT, laser, or the like) in the projection device. This embodiment also allows production of square-formatted hardcopies at the full resolution of the projection device.

In another embodiment of the printer, the production of both horizontal and vertical hardcopy formats at full resolution is accomplished by allowing the projection device itself to rotate 90 degrees from one orientation to another orientation around the axis of its projection path.

Generally, lenticular hardcopies are positioned with lenticules oriented vertically for autostereoscopic hardcopies (both animated and non-animated) and horizontally for non-stereoscopic hardcopies (both animated and non-animated). A hardcopy with the lenticules oriented horizontally when viewed correctly is a non-stereoscopic hardcopy. Although non-stereoscopic “animated” hardcopies with the lenticules oriented vertically can be viewed, vertical orientation can result in ghosting between the individual images. This ghosting can result in a less profound animation effect compared to a horizontal lenticular orientation. With non-stereoscopic animated lenticular hardcopies, when the lenticules are oriented horizontally, an image appears (to the viewer) to be animated either when the hardcopy is rotated up and down (i.e., where the rotation is around an axis parallel to an axis oriented along the length of the lenticules) or when the eyepoint of the viewer (i.e., viewpoint) is moved up and down in relation to the hardcopy. Imaging and projection devices generally available for use as exposure devices for the printer produce images that are rectangular in format, due to the industry-standard, rectangular format of matrix and non-matrix displays utilized in conventional imaging and projection devices.

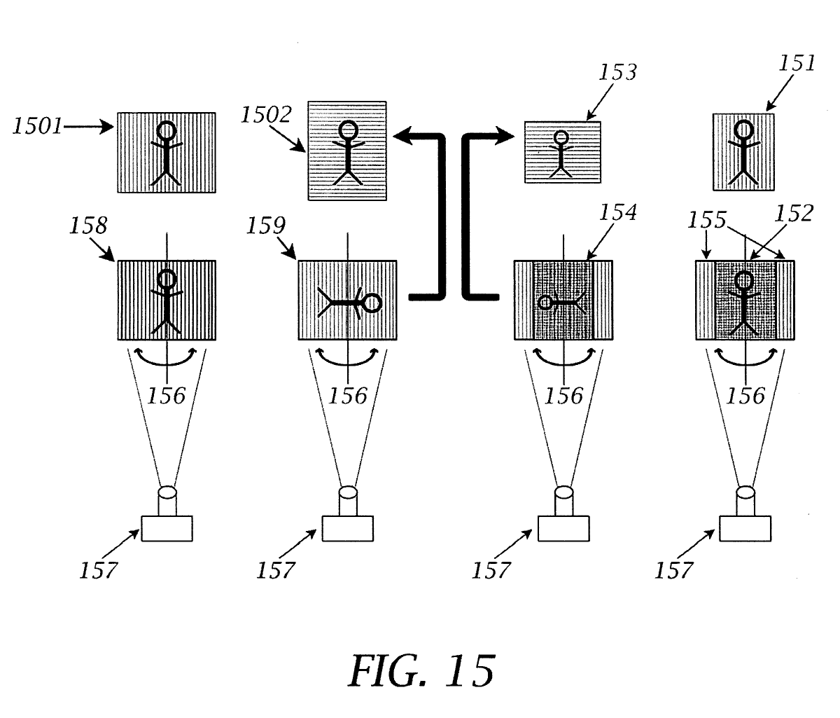

In FIG. 15, the bottom row of rectangular images (158, 159, 154, 152) shows the lenticules on different hardcopy images oriented in relation to a captured scene during exposure by a printer. The top row of rectangular images (1501, 1502, 153, 151) shows the lenticules oriented in relation to a captured scene when the hardcopy is viewed. The parallel lines in each rectangular image show the orientation of the lenticules. If there is only one axis of rotation (156), a user is limited to horizontally-formatted (i.e., landscape-formatted) autostereoscopic hardcopies (1501) at full pixel resolution and/or vertically-formatted (i.e., portrait-formatted) non-stereoscopic hardcopies (1502) at full pixel resolution. This assumes that the projection (i.e., exposure) device is permanently mounted in an orientation perpendicular to the axis of rotation. Therefore, assuming the exposure device is mounted permanently in an orientation perpendicular to the axis of rotation, production of a portrait-formatted autostereoscopic hardcopy (151) would require vertical orientation of the lenticules on the material plate (152). The material plate would rotate only around its vertical axis (156) and this configuration would be able to produce only a relatively small image (151) with a reduced pixel count, since a portion of the area (155) on the printer-based light-sensitive lenticular material would not be utilized. As a result, it would not be possible to utilize the full resolution of the projection device, and a portion of the printer-based light-sensitive lenticular material (155) would be wasted. If production of a landscape-formatted non-stereoscopic lenticular hardcopy (153) is desired, the lenticules could be oriented vertically on the material plate (154). The material plate would rotate only around its vertical axis (156) and it would only be possible to produce a relatively small image (153) with a reduced pixel count.

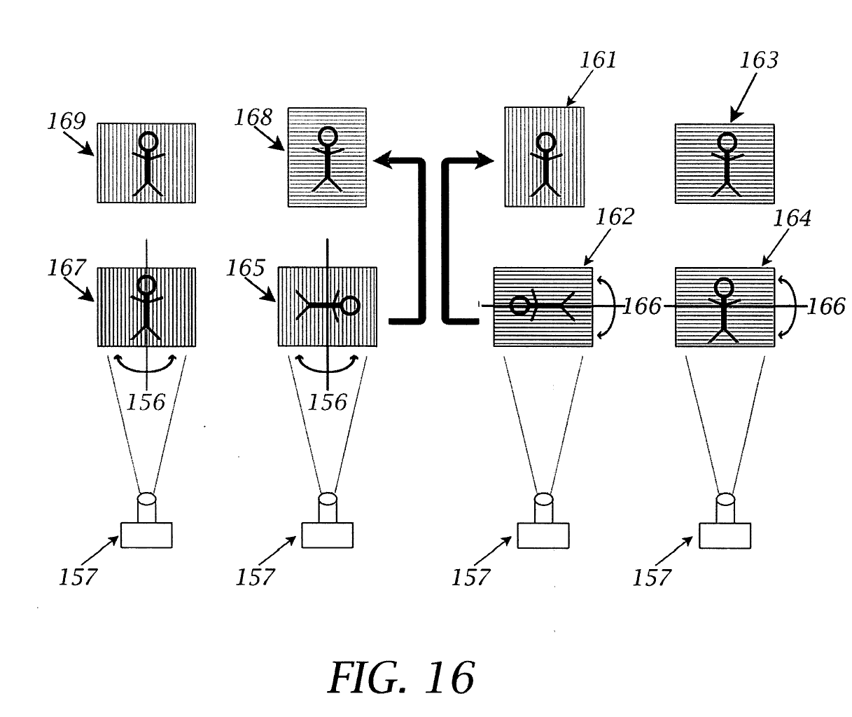

In FIG. 16, the bottom row of rectangular images (162, 164, 165, 167) shows lenticules on different hardcopy images oriented in relation to a captured scene during exposure by the printer. The top row of rectangular images (161, 163, 168, 169) shows lenticules oriented in relation to a captured scene when the hardcopy is viewed. The parallel lines in each rectangular image show the orientation of the lenticules. FIG. 16 shows the present printer where the material plate rotates around both its vertical axis (156) and horizontal axis (166), so that the material plate can accommodate both horizontally-formatted and vertically-formatted printer-based light-sensitive lenticular material. As a result, the printer can produce horizontally-formatted (169) and vertically-formatted (161) autostereoscopic hardcopies at full resolution and horizontally-formatted (163) and vertically-formatted (168) non-stereoscopic (i.e., animated) hardcopies at full resolution. Thus, the resolution capability of the projection device employed by the printer can be maximized and waste of the printer-based light-sensitive lenticular material can be minimized.

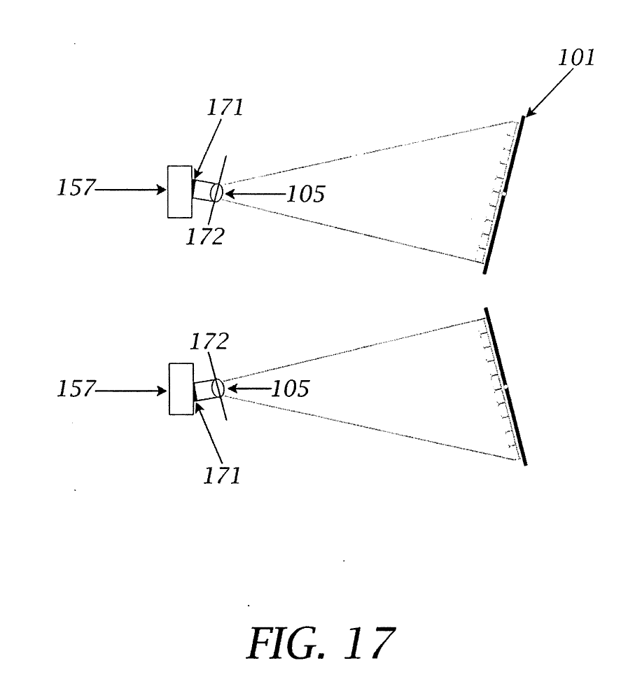

FIG. 17 shows the printer with the projection device (157) utilizing built-in manual, automatic, or motorized Scheimpflug correction (171), to compensate and bring the plane of the material plate (101) more parallel to the lens plane (172) when the material plate (101) is rotated off-center. Here, extreme rotation angles of the material plate can result in the depth-of-focus being insufficient, without Scheimpflug correction being utilized. Scheimpflug correction allows for the top, bottom, left and right sides of an image projected onto the material plate (101) to be more uniformly in focus, even when the plane of the panel in a projection device (157), such as an LCD or DLP panel, is not parallel to the plane of the rotated material plate (101). The correction occurs by tilting the lens (105), and thus the plane of the lens (172), toward a position where the plane of the lens (172) is parallel to the plane of the rotated material plate (101). This correction (171) can be particularly useful when the lens of the projection device utilizes large aperture settings. The Scheimpflug correction can be implemented manually or with motors.

The present printer can also include a digital image preview device, such as is common in conventional digital cameras and video cameras. These preview devices can incorporate a conventional 2D type of display, such as an LCD or monitor. Alternatively, an autostereoscopic display can be utilized for the printer's preview device. Examples of autostereoscopic displays that can be utilized for the printer's preview device include: those developed or offered by 3D Media Solutions, 3D Technology Laboratories, 4-D Vision GmbH, Deep Video Imaging, Dimension Technologies Inc., Dresden 3D GmbH, Ethereal Technologies, Heinrich-Hertz Institut for Communication Technology, MIT Media Laboratory, NEC, NYU Media Research Lab, Philips, Reality Vision Ltd., Sanyo, SeeReal Technologies GmbH, Sharp, StereoGraphics, NEC, Vizta 3D, or Zynex. Generally, the more parallax of a series of images captured of a three-dimensional object or scene, the greater the stereoscopic (i.e., 3D) effect in an autostereoscopic hardcopy printed from those images. If an autostereoscopic version of a preview device is used, the parallax presented by the difference in viewing angles between the different exposure angles can be represented and viewed stereoscopically in the autostereoscopic monitor prior to printing. The viewing angle parameters can be adjusted prior to exposing the printer-based light-sensitive lenticular material, in order to adjust the amount of parallax present in the exposed and processed autostereoscopic hardcopy. Using this digital autostereoscopic preview and adjustment technology, a desired autostereoscopic effect can be obtained in the printed hardcopy.

Many different types of printer-based light-sensitive lenticular material can be utilized in the present printer. Material plate rotation positions and other internal operating parameters of the printer can be set to accommodate different optical properties of different printer-based light-sensitive lenticular materials. Optical properties of printer-based light-sensitive lenticular materials are determined in part by the shape and size of the lenticules. Alternatively, various printer-based light-sensitive lenticular materials can be manufactured to accommodate optimal or desired projection and printing parameters of the present printer. For example, one type of printer-based light-sensitive lenticular material can be manufactured to achieve optimal autostereoscopic hardcopy viewing, while a different type of printer-based light-sensitive lenticular material can be manufactured to achieve optimal non-stereoscopic animated hardcopy viewing. The printer can be interactively set up or programmed to utilize projection and printing parameters that correspond to the optical and material characteristics of a specific printer-based light-sensitive lenticular material. Alternatively, an inexpensive simple version of the printer could be manufactured with a finite number of pre-determined material plate positions available. One or more printer-based light-sensitive lenticular materials could then be manufactured to accommodate the specific requirements of this simplified and possibly standardized version of the printer.

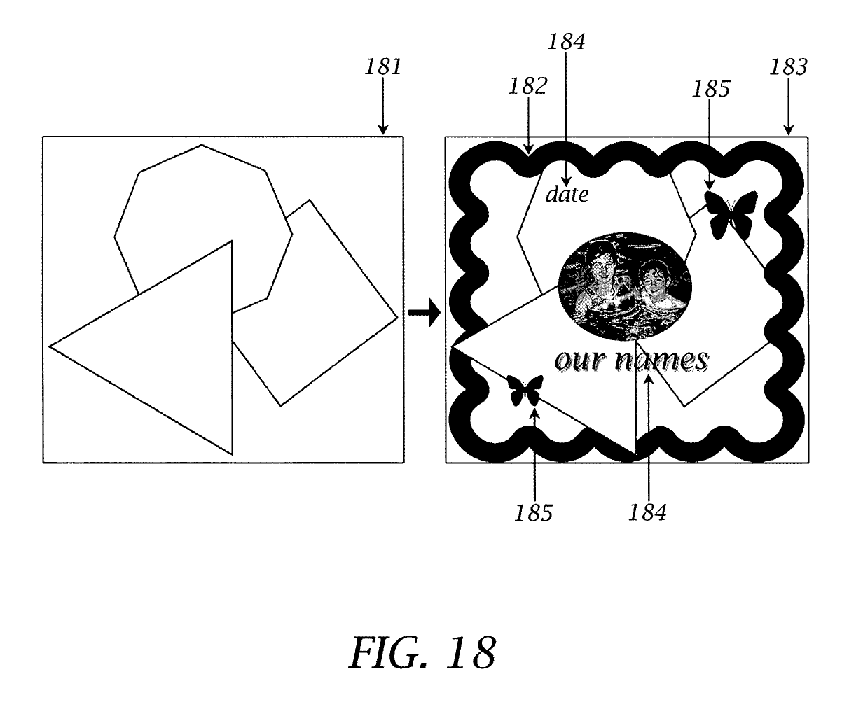

During image processing (i.e., prior to exposure of the lenticular material), the exposure density of hardcopies (both autostereoscopic and non-stereoscopic) optionally can be manipulated by increasing or decreasing the saturation levels in the image data, to the point that specific areas of the image can be lightened or darkened relative to other areas of the same image. As shown in FIG. 18, an alternate image processing technique can be used for creating a 3D mask (182) that floats above or within the viewed stereoscopic or non-stereoscopic images (181, 183), into which can be inserted virtually any type of additional stereoscopic or non-stereoscopic digital image content desired. This image processing technique allows interactive insertion of text (184) or numbers, 2D or 3D objects (185), and any other item accessible by the imaging software in a compatible digital image file format. Image processing can also be used during this phase to present the image differently, such as with conventional photo presentation and manipulation software. For example, Photoshop® includes filter effects that can be applied to an image or as a batch to all images in a stereoscopic or non-stereoscopic series.

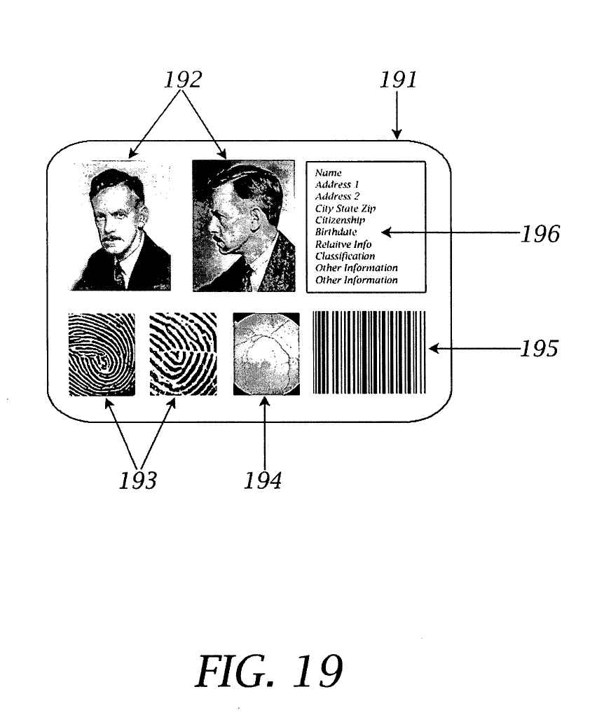

Additional image processing techniques can provide increased versatility for the printer to allow 2D and 3D objects, photographs, drawings, text, as well as 2D and 3D scanned images and objects, and other image files, to be added into the image composition to optimize the printer's use for specific applications. For example, as shown in FIG. 19, a present printer can use its image processing software for security applications, such as to create secure identification (ID) cards, labels, tickets, or seals for stocks, bonds and other official documents. A secure ID (191) could include, for example, 2D or 3D photos of the subject (192) from one or more angles, descriptive text, 2D or 3D fingerprint data (193), 2D or 3D barcode data (195), 2D or 3D retinal scan (194) or other biometric data, 2D or 3D text-based data (196), and 2D or 3D image-based data to increase the personalization of the ID. Examples of types of secure ID cards that can utilize this technology include: secure driver licenses, voter ID cards, passports, and government employee ID cards. The secure ID and other secure identification materials created can also utilize many features found in conventional secure cards, including “smart card” chips and technology and magnetic strips for digitally storing and accessing information. For medical and scientific applications, descriptive text identifying the subject or time or circumstances, fingerprint (and/or footprint) data, numerical measurement data, and any other text-based or image-based information can be added into one or more images for the production of autostereoscopic and non-stereoscopic hardcopies. For entertainment applications, photographic data, descriptive text, and any other text-based or image-based information can be added to increase the level of customization of the final autostereoscopic or non-stereoscopic hardcopy.

The printer's image processing software can operate in a computer embedded in the printer itself or, alternatively, it can operate in a computer external to, but connected to, the printer. The printer's image processing software also can operate in a computer external to, and not connected to, the printer. Further, automated kiosks can be utilized to house or interface the printer with a user-friendly workstation and other components such as a digital camera and image scanner or other image capture device, to facilitate more easily the commercial exploitation of the security, medical, entertainment, and other specialized applications.

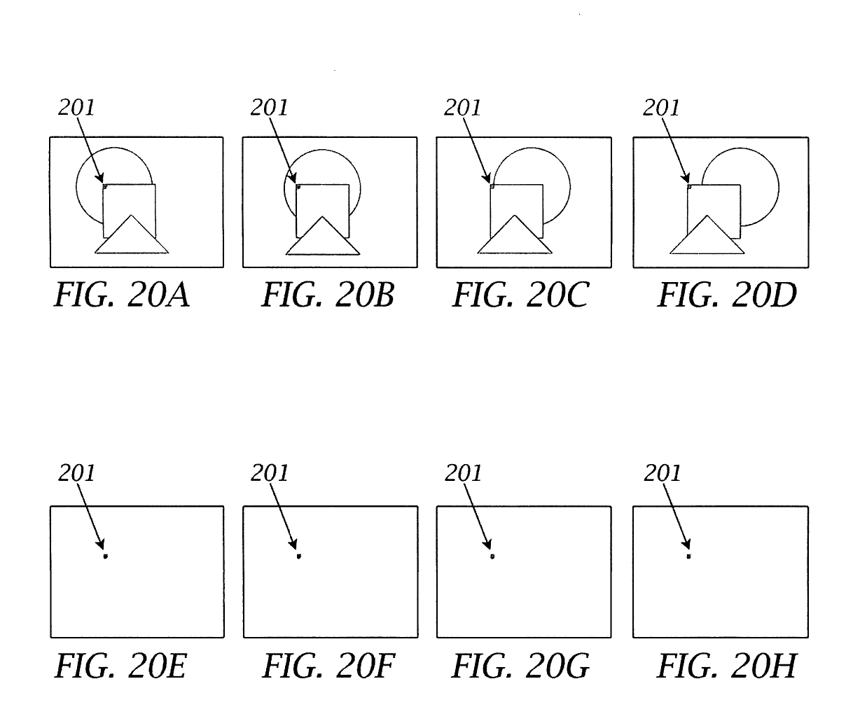

The present printer includes software to align a series of images that were inherently misaligned due to the method of creation or acquisition of the images. When generating a series of images via 3D modeling and rendering software, for example, the images can be automatically aligned according to a common target or subject point as determined by the instructions for the rendering of the images. Therefore, with this example, no additional alignment generally is necessary prior to printing onto printer-based light-sensitive lenticular material for autostereoscopic and non-stereoscopic hardcopies. However, with images acquired via scanning or other image capture processes, or via some digital photographic methods, it is sometimes necessary to pre-align the images relative to each other in order to obtain the desired autostereoscopic or animated effect in the finished hardcopy. As shown in FIG. 20A to FIG. 20H the alignment process operates by selecting a key subject or “target” point (201) in the first “reference” image (FIG. 20A) in a series of images (FIG. 20A to FIG. 20D), then locating the same or similar point (201) in each of the other images (FIG. 20B to FIG. 20D) in the series, and then shifting each of these other images (FIG. 20B to FIG. 20D) in the series to match the relative position of the target point (201). When each of the images (FIG. 20A to FIG. 20D) is exposed onto the printer-based light-sensitive lenticular material, the target point (201) is aligned in the same relative position in all of the exposed images (FIG. 20E to FIG. 20H).

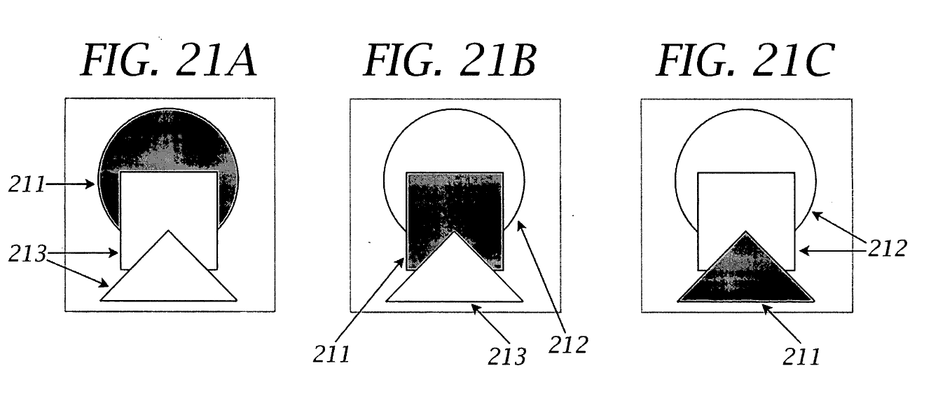

As shown in FIG. 21, the alignment software's graphical user interface allows a user to interactively manipulate the variables that set the perceived depth location of the key subject (211) or reference plane to create different images (FIG. 21A to FIG. 21C). The reference plane is the plane of the key subject (211), behind which objects are perceived to be in the three-dimensional background (212), and in front of which objects are perceived to be in the three-dimensional foreground (213) of a scene in an autostereoscopic hardcopy. Using this interactive alignment process, a user can determine the key subject and can control how the individual images in a stereoscopic sequence are to be aligned when printed. The printer's alignment software can operate in a computer embedded in the printer itself or, alternatively, the software can operate in a computer external to, but connected to, the printer. The printer's alignment software can operate also in a computer external to the printer and not connected thereto.

The present printer can produce autostereoscopic and animated hardcopies from both digital media and non-digital media. The printer includes a conventional electronic image capture device (for example, an image scanner, or other digital image recording device, such as one that includes one or more CCD or CMOS chips) to electronically capture image data from one or more negatives, transparencies or prints. The printer also includes a computer, which can be built into the printer housing or located external to the printer. The computer can also be located, for example, in the projection device. The electronic image capture device can be attached directly to the printer or, alternatively, the capture device can be attached to a separate computer workstation, which is connected to the printer. Masks formatted to accommodate multiple-image photographic negative sets and other media formats can be utilized by the image capture process in order to increase efficiency. When the media is provided in a digital format, rather than as a negative, transparency or print, the electronic image capture device is not utilized. The printer can receive digital content via any digital source, including: a digital camera, a video camera, a computer hard drive, a computer memory chip, or any digital storage medium (e.g., CD, DVD, floppy disk, data cartridge, memory card, memory stick, magnetic tape, or the like). The printer can also receive digital content via a network-based or internet-based conveyance, including: a cable feed, a satellite feed, a website, a modem, an ftp site, an email, an instant messaging system, or a network. Digital content can also be conveyed to the present printer via a wireless data transfer method.

When the electronic image capture device is used to capture data from only one negative, transparency or print, the data can be image-processed with the printer's image-processing software detailed herein and sent to the printer's exposure device. When data is captured from a multiple-image set of negatives, transparencies or prints, the individual images can be image-processed, aligned to each other using the printer's alignment software detailed herein, and sent to the printer's exposure device; pre-aligned and ready for printing. Thus, the printer can be used to print autostereoscopic and animated hardcopies from digital media; stereopairs, including View-Master® reels and content generated by stereopair film cameras; sheet films; prints; and multiple-image negative and transparency films (including 120/220, 35 mm half-frame and 35 mm full-frame) generated by multiple-lens 3D film cameras including those produced or distributed by Kalimar, Nimslo, Nishika, 3D Image Technology, and 3-D Images Ltd.

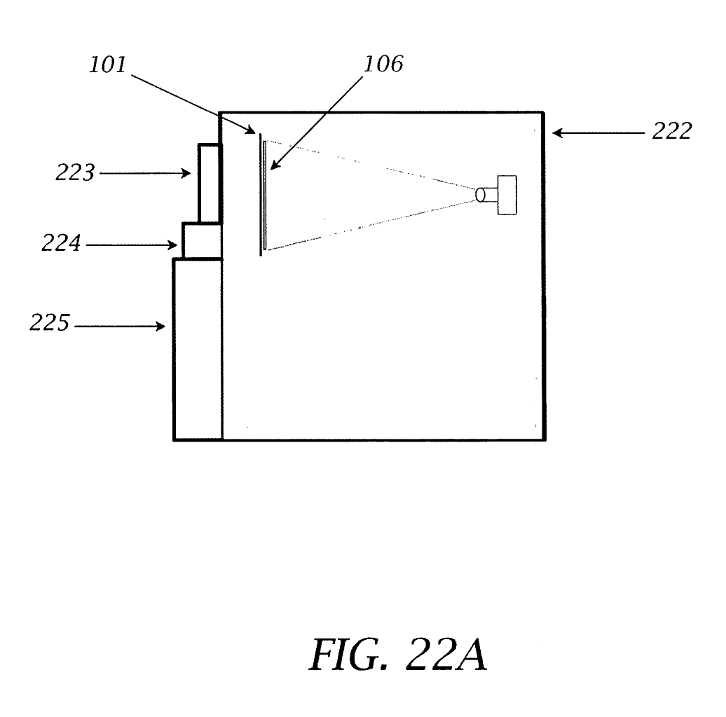

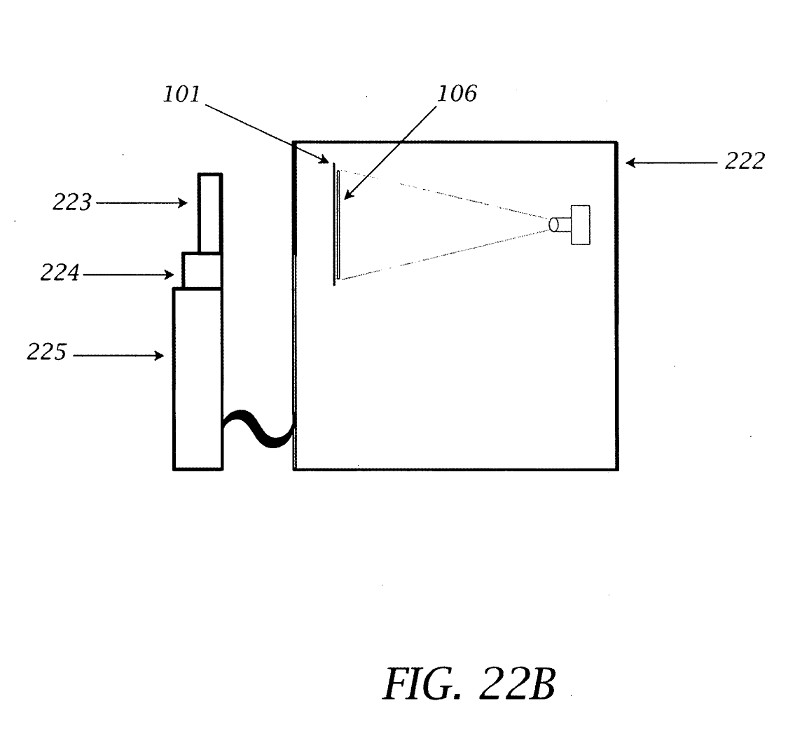

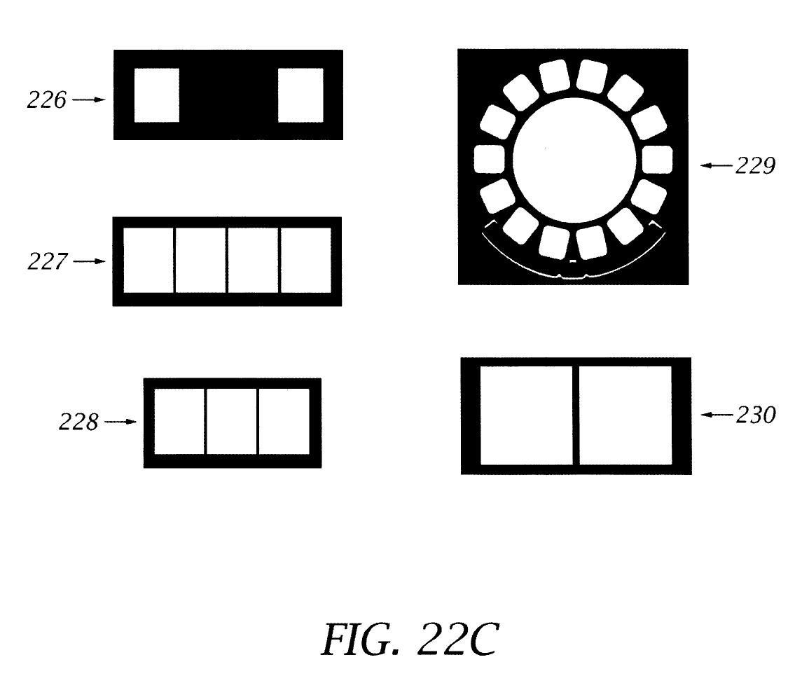

FIG. 22A shows a printer (222) capable of producing autostereoscopic and animated hardcopies from both digital media and non-digital media. The printer's electronic image capture device (224) is attached physically to the printer (222) and connected electronically to a computer (225) that is attached and connected to the printer (222). An autostereoscopic monitor (223) is connected to the computer (225), attached to the printer (222), and utilized as a preview device. FIG. 22B shows an alternate embodiment of a printer (222) capable of producing autostereoscopic and animated hardcopies from both digital media and non-digital media. The printer's electronic image capture device (224), computer (225), and autostereoscopic monitor (223) are external to the printer (222). An electronic image capture device (224) and autostereoscopic monitor (223) are connected to a computer (225), and the computer (225) is connected to the printer (222). FIG. 22C shows five examples of non-digital media masks (226-230) that can be utilized by the printer shown in FIG. 22A or FIG. 22B to more easily facilitate a multiple-image capture and alignment. A Realist® 35 mm film stereopair mask (226) is used to capture and record image data from this particular Realist® format. A Nimslo® three-image half-frame 35 mm film mask (227), an ImageTech™ four-image half-frame 35 mm mask (228), a View-Master® mask (229), and a Holmes stereopair print mask (230) are also shown.

Alternatively, the present printer can produce autostereoscopic and animated hardcopies from both digital media and non-digital media and utilizes two separate exposure devices contained inside the printer. One device is a projection display device as described herein, and the second device is an illumination device that projects light through one or more negatives or transparencies to expose printer-based light-sensitive lenticular material positioned on the material plate. Each of these two devices can project onto the light-sensitive lenticular material from a different fixed position inside the printer, where the light path of the illumination device is perpendicular to the plane of the material plate at its center position. Here, the light path of the projection display device is at an oblique angle to the material plate and the images from the projection display device are pre-distorted to compensate for the distortion caused by the oblique projection angle. Further, the illumination device has a means to advance the negative or film transparency in both directions laterally and to align the key subject point of individual negative of film images to each other. Alternatively, the light path of the projection display device can utilize one or more mirrors between the device and the material plate to fold the light path. Alternatively still, the light path of both exposure devices can utilize one or mirrors between the devices and the material plate, and the mirror or mirrors can be rotated to direct the projected light from one or the other of the exposure devices onto the material plate. In yet another embodiment, the position of each of the two exposure devices can move to allow the light path of the “active” exposure device, being utilized for exposure, to extend in a straight line between the active exposure device and the material plate.

The present printer can include software that calculates the viewing angles of three-dimensional datasets generated by three-dimensional software applications or three-dimensional imaging apparatuses to produce autostereoscopic hardcopies from three-dimensional datasets. This calculation software can utilize tags to identify the location of foreground, background, and key subject objects in a three-dimensional dataset to determine the optimal or suggested placement of these objects in three-dimensional space, or to determine viewing angles to be rendered for autostereoscopic printing. To perform such viewing angle determination, the software calculates a virtual camera's position for a series of different equidistant viewing angles captured from a three-dimensional dataset. Here, if <T> is given as the distance from the virtual camera to the Target (the key subject point—ideally the point at which the virtual camera is aimed), <F> is the distance from the virtual camera to the tagged object in the scene closest to the virtual camera, <B> is the distance from the virtual camera to the tagged object in the scene farthest from the virtual camera, and <V> is a coefficient equal to 0.0011727 (assuming a virtual camera's angle of view approximately equal to a 50 mm lens on a 35 mm camera), the distance <P> between any two adjacent positions of the virtual camera as the location of the virtual camera changes to capture a series of viewing angles can be calculated with the following equation:

$$( \frac{( T \times F )}{( T - F )} + \frac{( T \times B )}{( B - T )} ) \times V = P$$

The numerical value of the coefficient <V> can be increased or decreased according to variables related to an application or dataset, including: the number of viewing angles captured, sizes of hardcopies to be printed, imaging modality or visualization device used, angle of view of virtual camera, or even subjective visual preference, in order to fine-tune the amount of desired parallax in the printed autostereoscopic hardcopy. For example, because some volumetrically rendered medical data can produce a lower contrast, more transparent, autostereoscopic hardcopy than similar data that has been surface rendered, the value for the coefficient <V> might be increased when printing from volumetrically rendered data to produce greater parallax in the printed autostereoscopic hardcopy. Once <P> is known, using equivalent alternative forms of the equation used to calculate <P>, the value for either <T>, <F>, or <B> can be calculated if the value for the other two variables are known to calculate the values, and thus placements of key image components in three-dimensional space, to print autostereoscopic hardcopies. Once a value for <P> has been calculated, a value in degrees for the angle <A> created by the point <T> and the difference in positions of the virtual camera for any two adjacent viewing angles of a series of viewing angles can be calculated with the following equation:

$${A}^{°} = asin ( \frac{P}{T} )$$

The printer's calculation software can operate in a computer embedded in the printer itself or, alternatively, the software can operate in a computer external to, but connected to, the printer. The printer's calculation software can operate also in a computer external to, and not connected to, the printer.

Additional stereopair printing-optimization software can be included in the present printer that facilitates the production of high-quality autostereoscopic hardcopies from digital or non-digital stereopairs. When an autostereoscopic lenticular hardcopy is produced from only two images that comprise a stereopair, optimal stereoscopic viewing of the resulting hardcopy image generally is confined to a limited viewing area positioned directly in front of the hardcopy. When the viewer moves even slightly from this optimal position, the stereoscopic effect can be reversed or flip-flopped, which produces an undesired viewing effect, generally referred to as “pseudo-stereo.” The range of the viewing area from where an autostereoscopic hardcopy can be optimally viewed can be referred to as the “sweet spot” viewing position of the hardcopy. In order to produce an autostereoscopic lenticular hardcopy with a wider sweet spot or optimal viewing area range, a hardcopy can be printed from a number of viewpoints greater than the two separate stereopair viewpoints of a three-dimensional object or scene. Here, the additional image or images represent one or more viewpoints in-between the two viewpoints from which the original two stereopair images were captured. Because capturing the one or more additional in-between viewpoints after the original stereopair images have been created is generally not practical, typically it is preferable to digitally create these additional “in-between” or intermediate viewpoints as synthesized images. Thus, this integral stereopair printing-optimization software component can create (i.e., synthesize) one or more in-between images in order to produce autostereoscopic hardcopies from stereopair data that can be viewed from a wider sweet spot. In one embodiment of the stereopair printing-optimization software, two original stereopair images are analyzed to determine the differences between the two images that exist due to the difference in parallax between the two images, and from the results of this image analysis process a three-dimensional depth map that represents this difference in parallax is created that allows for the generation of one or more in-between images. After the depth map is created, one or more additional in-between images can be generated and an autostereoscopic hardcopy can be printed from a series of viewpoints that includes the original two stereopair images plus one or more in-between images. A majority of the process utilized to create a depth map from two images that comprise a stereopair can be automated. In an alternate embodiment of the printer software, one or more in-between images can be created by analyzing the differences between two stereopair images and then averaging or blending together the two stereopair images to create additional in-between images that contain image components common to both original stereopair images, yet that are unique to each of the two stereopair images respectively. In another embodiment of the printer software, conventional morphing algorithms can be applied to two stereopair images, resulting in the creation of one or more in-between images that represent intermediate stages of the first stereopair image morphing into the second stereopair image. When an autostereoscopic hardcopy is printed from a set of images that includes the original stereopair images and the synthesized in-between images, the resulting hardcopy can exhibit a wider sweet spot, from which the hardcopy can be optimally viewed, compared to an autostereoscopic hardcopy printed from only the original two stereopair images. The printer's stereopair printing-optimization software can operate in a computer embedded in the printer itself or, alternatively, the software can operate in a computer external to, but connected to, the printer. The printer's stereopair printing-optimization software can operate also in a computer external to, and not connected to, the printer.

Additional stereoscopic conversion software that can be included in the present printer facilitates the production of autostereoscopic hardcopies from a single digital or non-digital two-dimensional image, by converting a two-dimensional image into three-dimensional image data, which can then be printed as an autostereoscopic hardcopy. The stereoscopic conversion software analyzes the single image and creates a depth map that describes where key components in the image are positioned in three-dimensional space. After a depth map has been created from a two-dimensional image, one or more additional viewpoints of the three-dimensional image data can be created from positions determined by the depth map's parameters, and the printer can produce autostereoscopic hardcopies from the multiple viewpoints. A majority of the process utilized to create a depth map from a single two-dimensional image can be automated. The printer's stereoscopic conversion software can operate in a computer embedded in the printer itself or, alternatively, the software can operate in a computer external to, but connected to, the printer. The printer's stereoscopic conversion software can operate also in a computer external to, and not connected to, the printer.

The present printer with above-referenced software can be made available in an automated kiosk-based configuration, to facilitate user-friendly production and delivery of autostereoscopic and animated hardcopies.

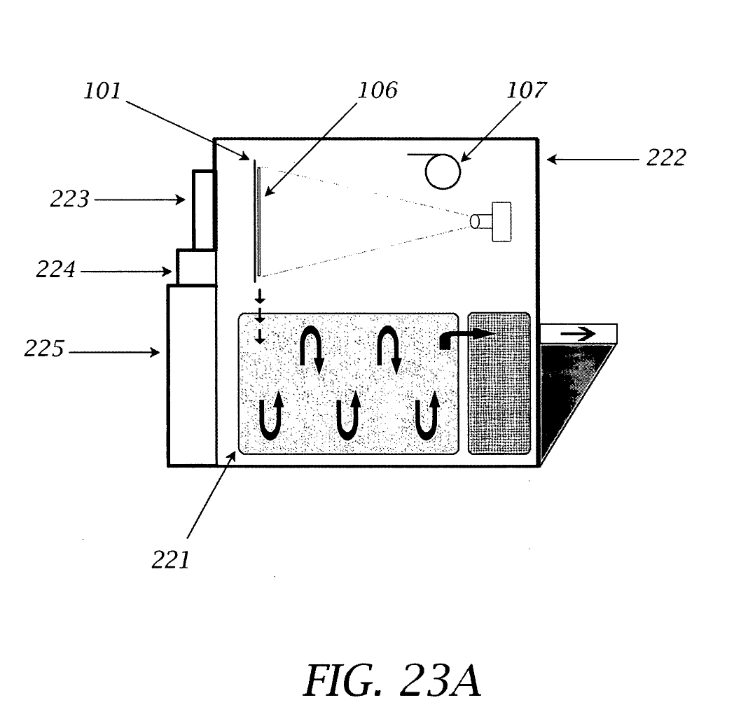

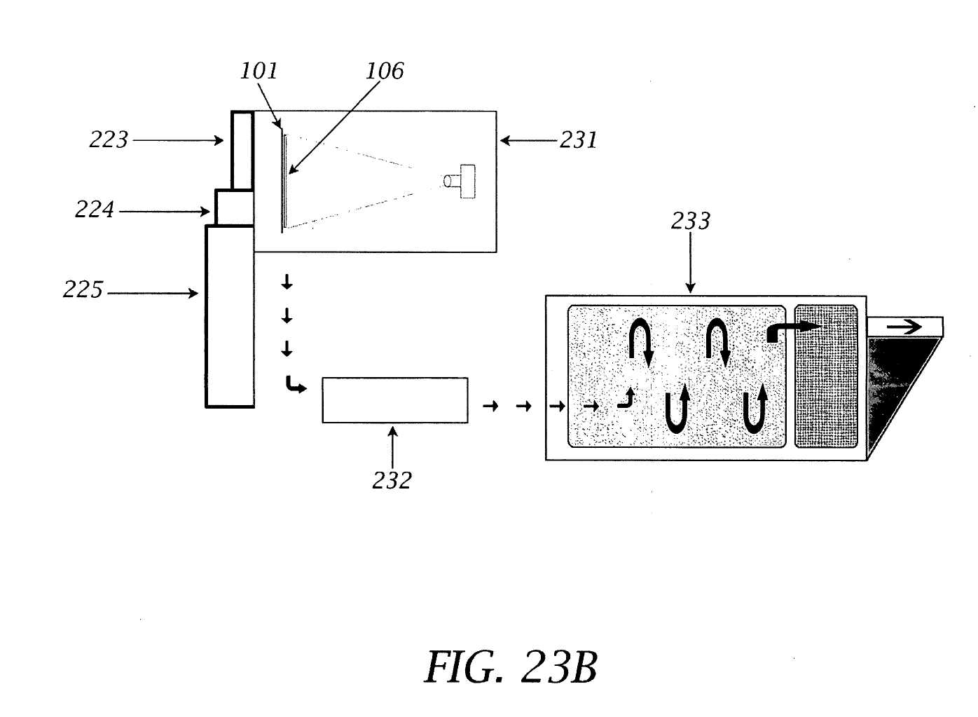

FIG. 23A shows an image-developing process built into a printer (222). A sheet of exposed printer-based light-sensitive lenticular material (106) is transported from the material plate (101), feeds via rollers through the photo-processing mechanism (221), and exits the printer (222) wet or dry. A roll (107) of light-sensitive lenticular material is shown internal to the printer and can be positioned anywhere as desired therewithin. The roll (107) of light-sensitive lenticular material can optionally be located external to the printer. FIG. 23B shows an alternate embodiment where exposed printer-based light-sensitive lenticular material (106) is removed from a printer (231), transported via a lightproof container (232), and fed into a separate photochemical processing apparatus (233), which chemically processes the exposed printer-based light-sensitive lenticular material (106).

The printer can utilize an instant-developing process with the printer-based instant-developing light-sensitive lenticular material described herein. The instant-developing process is analogous to the process utilized in various Polaroid® photo-processing technologies. However, in this embodiment, it is not necessary to employ a separate photochemical processing apparatus. The exposed printer-based instant-developing light-sensitive lenticular material can be processed by the specialized photochemistry contained within the layers of the instant-developing light-sensitive material. The printer-based instant-developing light-sensitive lenticular material can utilize an instant-developing type of film backing that contains rollers or other mechanisms to rupture one or more pods containing reagent fluid. The reagent fluid activates the instant-development process of the exposed instant-developing light-sensitive material. Alternatively, rollers or another mechanism can be contained in the printer or in an instant-developing apparatus separate from the printer. Alternatively, an instant-developing method can be utilized with the reagent and developer photochemistry coated on a separate sheet of material (rather than in one or more pods contained within the instant-developing light-sensitive material). The sheet of material is then pressed tightly for a period of time against the emulsion of the exposed instant-developing light-sensitive material to effect the instant-developing process.

The printer can print two-dimensional images, where only one view is projected onto printer-based light-sensitive lenticular material or onto a non-lenticular medium, such as photographic film or paper, and where only a single position of the material plate is utilized during the exposure process.

Camera

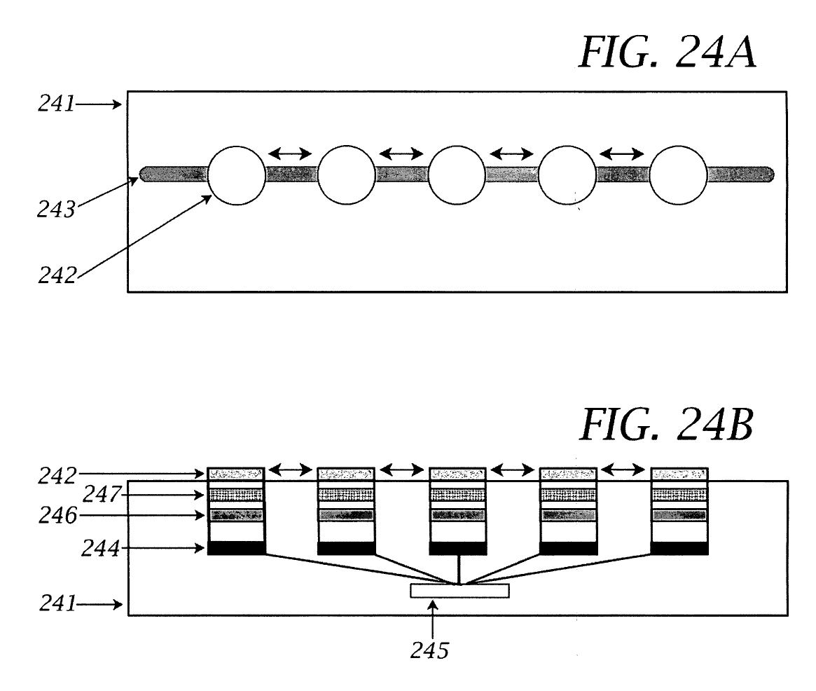

A camera can capture digital images from two or more viewpoints of a three-dimensional scene, with any two of these images usable as a stereopair for stereoscopic viewing. Two or more of the captured images can be utilized to produce autostereoscopic hard copy prints or transparencies. FIG. 24A and FIG. 24B show a camera (241) operable as a parallax-adjustable digital camera containing multiple lenses (242) positioned equidistant from each other along a horizontal path (243). The path (243) can be, for example, a straight line or a curve. Generally, the lenses (242) are preferably spaced farther apart the greater the distance away from the camera (241) objects in the field of view are. The spacing of the lenses helps maintain the desired three-dimensional effect when the images captured by the camera are printed as an autostereoscopic hardcopy image. If objects in the field of view are closer to the camera (241), generally the lenses (242) are preferably closer together to maintain desired parallax in the autostereoscopic hardcopy image. Each lens (242) can capture a view of a scene from a different viewing angle and can expose its image onto a digital image recording medium. Camera-based digital image recording media can include a digital-camera-optimized optical sensor chip (244) such as a charge-coupled device (CCD) or complementary metal oxide semiconductor (CMOS) that is dedicated to, and positioned behind, its corresponding lens (242) and is in a fixed position relative to the position of its corresponding lens (242). Each optical sensor chip is connected to one or more memory storage devices (245), which stores the data recorded by the sensor chip (244) to allow each sensor chip (244) to record multiple images. All of the lenses (242) can be easily repositioned along the horizontal path (243) to be farther away from each other or closer together, thereby increasing or decreasing the parallax created by the different viewpoints of two adjacent lenses as the distance between them increases or decreases. In FIG. 24A and FIG. 24B, the distance between any two adjacent lenses remains equal as the lenses are moved relative to each other. In alternate embodiments, the lenses can be moved independently and positioned so that adjacent lenses are not equidistant from each other. As each lens (242) moves along the horizontal path (243), its corresponding sensor chip (244) moves or tracks with it, so that each sensor chip (244) records an image from its corresponding lens (243), regardless of the position of the lens (243). The camera (241) also contains multiple shutters (246) and diaphragms (247), with one of each positioned between each lens (242) and its corresponding sensor chip (244). This configuration allows all of the shutters (246) to open and close simultaneously, so that the camera (241) can simultaneously capture and record images from several different viewpoints. If adjacent lenses (242) are positioned equidistant to each other, the images captured from any two adjacent lenses can be used as a stereopair without requiring additional calculations for a different parallax.

The camera can utilize many features found in conventional two-dimensional digital cameras, such as: programmable automatic exposure functions (with manual override), automatic focus functions (with manual override), white balance override functions, visual and audio annotation functions, multiple exposure functions, variable shutter and time-lapse exposure functions, built-in and external flash functions, variable flash synchronization speeds, sensor chips with multiple silicon layers (such as the X3 sensor from Foveon), various digital storage mediums, variable data compression functions, variable sensitivity or ISO range, viewfinder and LCD viewing screen options, Universal Serial Bus (USB) compatibility, FireWire™ (IEEE-1394) compatibility, self-timer functions, variable resolution functions, variable battery types, and variable lensing. The present camera also has the option of interactively opening the shutters individually (rather than all opening simultaneously) so that a series of images can be recorded in succession via one or more of the lenses. This process can be used to record a series of images in order to create an animation of the images. In one embodiment of the digital camera, the opening and closing of each shutter can be pre-programmed by the user, for the recording of timed or choreographed sequences, for time-lapse photography, or for remote operation. If a succession of images is acquired from one lens (and one stationary viewpoint), the resulting series typically is used to present a non-stereoscopic hardcopy image. If a succession of images is acquired from more than one lens, from one lens with the subject rotated, or, if the camera moved to different locations along a horizontal axis (and thus multiple viewpoints), the resulting series typically will present a stereoscopic image. In another embodiment, the camera also can be controlled by the user to determine when specific shutters should open and when specific sensor chips should record an image or series of images. These control features will allow only desired information to be recorded and reserve digital image storage space that will not be unnecessarily utilized by recording and storing an unwanted image. For example, if it were desired to capture only two images for the creation of a single stereopair, only the sensor chip behind each of the desired two lenses would record an image. If it is desired to utilize the camera to produce one or more 2D images, to record a series of images in succession through only one of the lenses (for an animation), or to capture a series of images from multiple viewpoints by moving the camera to different viewing positions, only the shutter and the sensor chip behind the lens of a desired viewpoint need be activated.

The digital images recorded with the camera can be utilized with the printer described herein. Other possible uses include: viewing images as stereopairs; producing lenticular-based autostereoscopic and animated hardcopy imagery by printing directly onto the back side of lenticular material or parallax barrier strip material; producing lenticular-based or parallax barrier-strip-based autostereoscopic and animated hardcopy imagery by laminating a layer of lenticules or parallax barrier strip material onto a 2D print or transparency produced by known 2D printing methods (e.g., photographic printing, lithographic printing, inkjet printing, laser printing, dot matrix printing, thermal printing, dye sublimation printing, etc.) that show rows or columns of image bands comprising interleaved or interlaced segments of images captured from different viewpoints or of an animated series; or any stereoscopic or non-stereoscopic or hardcopy application that utilizes a time-sequential or view-disparate sequence of 2D views.

In another embodiment, the camera is a fixed-parallax version with three or more lenses, with the position of each of the lenses, and thus the amount of parallax, being fixed. The camera thus can be simplified and manufactured more easily and less expensively than parallax-adjustable versions. In another embodiment, the camera can have multiple lenses and a single sensor chip, rather than multiple sensor chips as described above. In such embodiment, only one image is recorded at a time. Many multi-lens single-sensor chip cameras are envisioned, including those detailed in the following examples:

### EXAMPLE 1

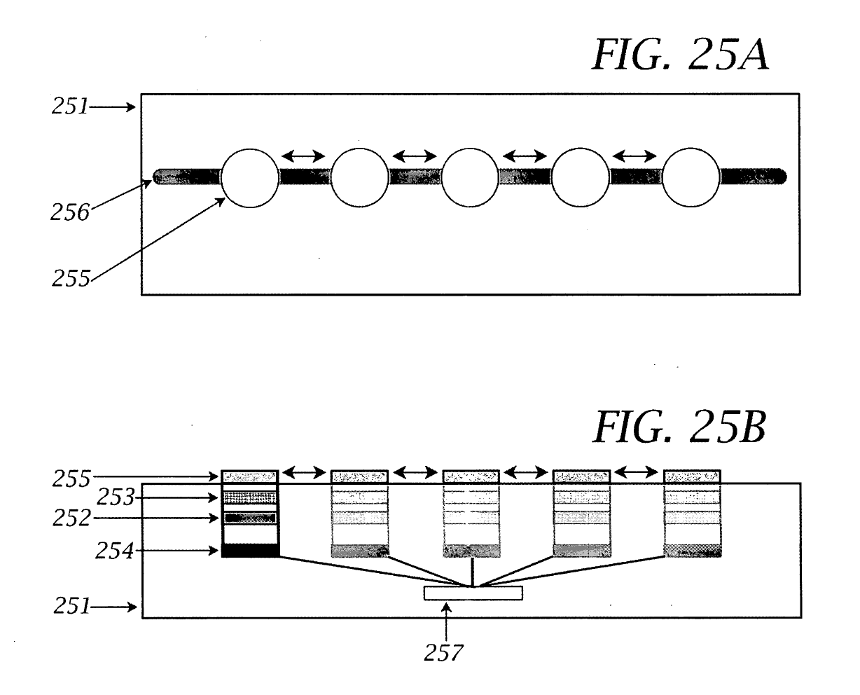

FIG. 25A and FIG. 25B show a camera (251) with a single shutter (252) and diaphragm (253) positioned between a sensor chip (254) and a lens (255). The sensor chip (254), diaphragm (253), and shutter (252) move together along a horizontal path (256) beneath the lenses (255) to allow a sensor chip (254) to be positioned to accept an image from any one of the lenses (255). A single 2D image can be exposed through any of the lenses (255) or a series of exposures can be made in succession via two or more of the lenses (255), in which case the sensor chip (254) records each of the series of exposures in succession and each image is stored in a memory storage device (257) prior to capture of a subsequent exposure. Alternatively, each of the lenses can have a dedicated diaphragm, where only the shutter and sensor chip move together beneath the lenses to accept and record each exposed image. Alternatively still, each of the lenses can have its own dedicated diaphragm and shutter, with only the sensor chip itself moving beneath the lenses to accept and record each exposure.

### EXAMPLE 2

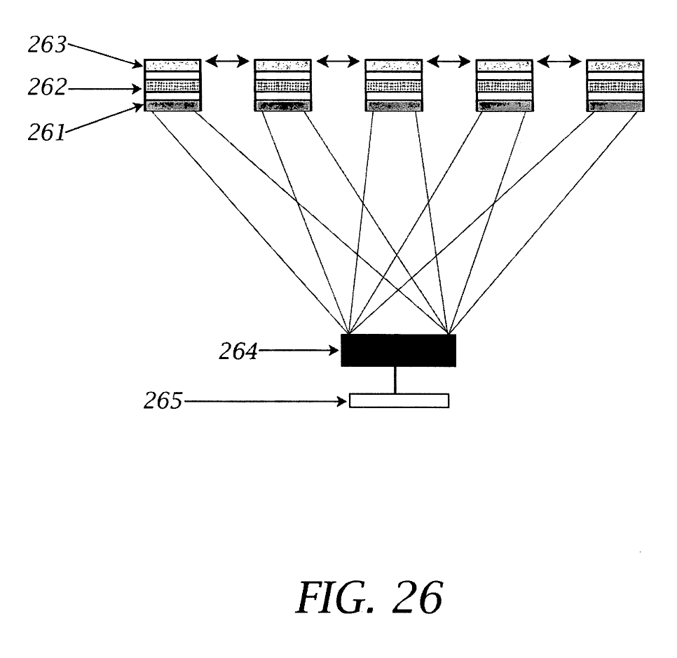

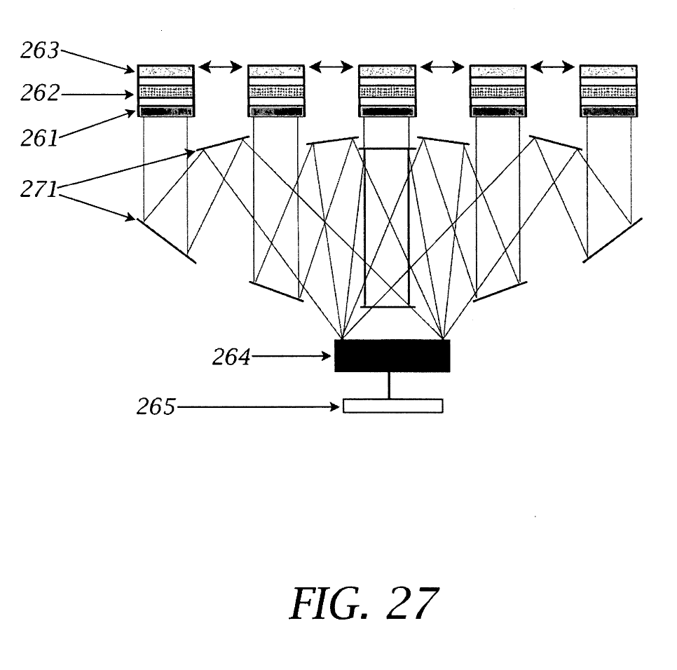

FIG. 26 shows the camera with a shutter (261) and diaphragm (262) positioned beneath each of the lenses (263). Here, the lenses (263) are constructed and oriented such that an image captured by each lens (263) is directed to a single common sensor chip (264). A single 2D image exposure can be made via any of the lenses (263) or a series of exposures can be made in succession via two or more of the lenses (263). The sensor chip (264) records each image in a series of exposures in succession and each image is stored in a memory storage device (265) prior to subsequent exposures. FIG. 27 shows a variation of this example, where, rather than relying only on the construction and positioning of the lenses (263) to direct each exposure onto the single common sensor chip (264), one or more mirrors (271) can be positioned between the sensor chip (264) and each of the lenses (263). Mirrors (271) can be utilized in any of the present camera versions to “fold” the exposure light path and thereby reduce the depth dimension of the camera. The center lens can be positioned directly in line with the sensor chip (264) without requiring a mirror to reflect the image from the center lens onto the sensor chip (264). However, as shown in FIG. 27, the exposure light path of the center lens can be folded by one or more mirrors.

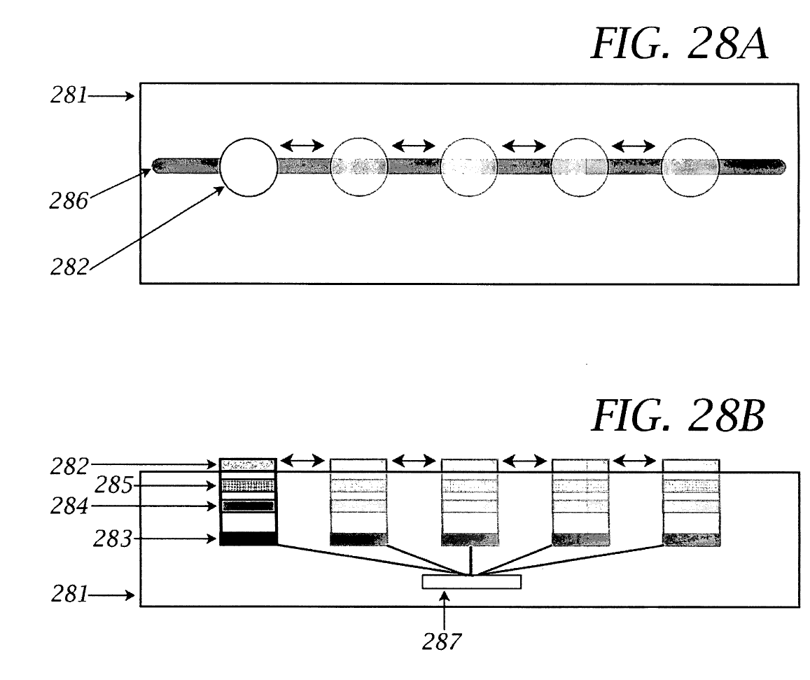

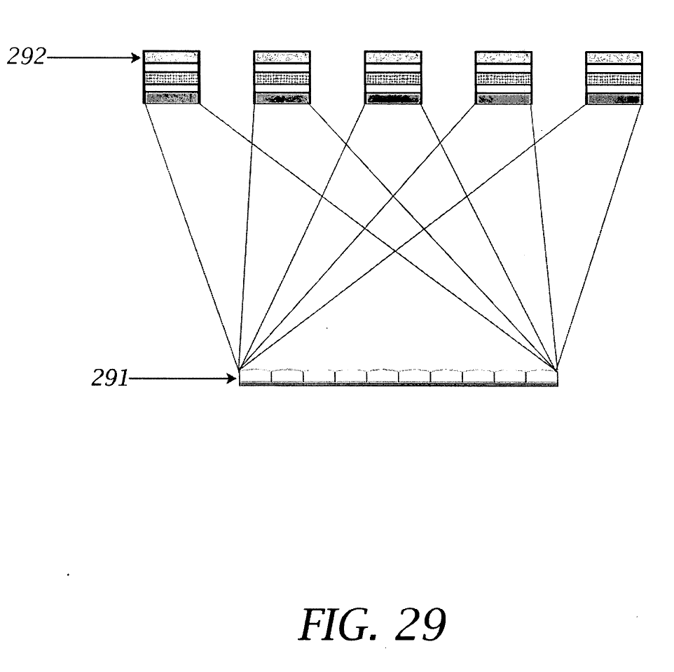

FIG. 28A and FIG. 28B show a simplistic version of the present camera with a single lens (282) and a single sensor chip (283). The lens (282), sensor chip (283), shutter (284), and diaphragm (285) can all move along a horizontal path (286) and can either stop at pre-defined lens positions or move to any spot between the two end points. The horizontal path (286) can be any configuration but, generally, the path (286) is either a straight line or a curve. An image can be recorded by the sensor chip (283) at any lens position. Like the multiple-lens single-chip camera versions, this camera version does not allow for simultaneous capturing of more than one digital image at a time. However, stationary views for studio photography, landscapes, or still life scenes can be captured in succession for desired stereoscopic results, as well as for non-stereoscopic animated hardcopies. Provided that the image is recorded by the sensor chip (283) and stored quickly, the faster the lens/sensor chip assembly can be moved into a new position, the more quickly images can be captured. This quick capture also provides for increased versatility since the duration of the entire sequence shortens. The memory storage device (287) can move with the lens-diaphragm-shutter-sensor assembly or, alternatively, the device (287) can remain in a stationary position, wired to the sensor chip (283).

A user can manually move one or more of the camera's individual or combined components (e.g., lens, diaphragm, shutter, sensor chip, memory storage device), or the components can be moved with motors. The user also can pre-program the timing and location of the movement of any of the components.

Many embodiments of the camera are envisioned, such as a camera with a single large lens opening, a single shutter, and a single moving diaphragm to expose one or more sensor chips from different viewpoints. Multiple images can be digitally captured (from multiple viewpoints and/or of different scenes or environments) and directly recorded onto one or more sensor chips, or onto a digital photo recording device.

The present digital camera versions can also be configured to capture and record onto digital recording media series of moving images, where the camera functions as a video capture device in addition to functioning as a still image capture device. The captured moving images can comprise stereoscopic or non-stereoscopic content in digital video or other digital moving image formats. Here, stereoscopic (3D) content can be displayed stereoscopically on an autostereoscopic monitor or via a stereoscopic projection system or other stereoscopic video or moving image display system. Further, non-stereoscopic content can be displayed on a conventional monitor or projection system. Autostereoscopic or non-stereoscopic animated (or non-animated) lenticular hardcopies can be printed from the captured moving images. The present digital camera versions can be configured to record one or more images onto negative or positive photographic film through conventional video-assist technology. In conventional video-assist technology, a beam splitter typically splits the light entering through the lens, sending a portion to the optical sensor chip and a portion to the film to be exposed. With camera versions configured to capture and record moving images as described above, moving image sequences can be first viewed on the camera's preview monitor to allow one or more images from a sequence to be selected and subsequently recorded on photographic film.

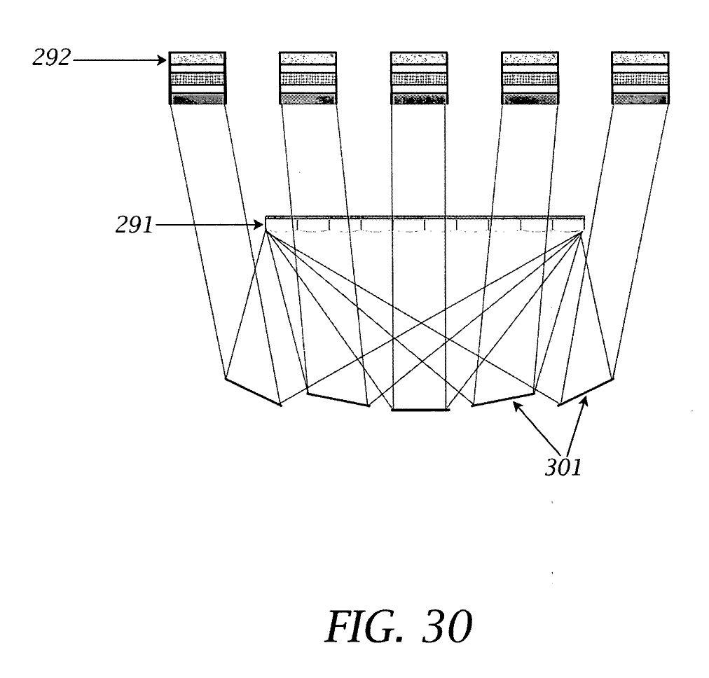

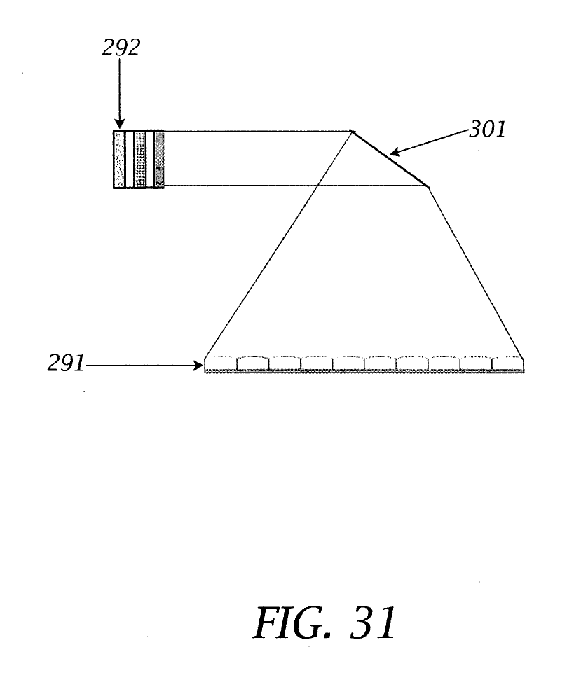

FIG. 29 shows a camera where non-digital images are recorded. The camera-based light-sensitive lenticular material (291) described herein is the recording medium shown, but can encompass other setups. The shown camera-based light-sensitive lenticular material includes instant-developing light-sensitive material as described herein, but can include other materials. This non-digital camera, analogous to the digital image camera discussed herein, contains a series of multiple lenses (292) that are positioned equidistant to each other along a horizontal axis. Each of the lenses (292) captures a view of a scene from a different viewpoint to allow any two of the captured views to represent a stereopair of the scene. Each of the lenses (292) is oriented such that an image is exposed via each lens (292) onto a sheet of camera-based light-sensitive lenticular material (291) positioned behind the lens (292). All of the images from the lenses (292) are focused and aligned on the camera-based light-sensitive lenticular material (291). With this particular configuration, the images exposed onto the camera-based light-sensitive lenticular material (291) typically appear as mirrored images when the hardcopy is viewed through the lenticules. Also, the lens design required to produce an accurate alignment of all images for this configuration can be complex, and therefore expensive. As shown in FIG. 30 and FIG. 31, an odd number of mirrors (301) are positioned between the camera-based light-sensitive lenticular material (291) and each of the lenses (292) to direct, focus, and align with its corresponding mirror or mirrors (301) onto the camera-based light-sensitive lenticular material (291). These mirrors (301) can also function to effectively fold the exposure path between each of the lenses (292) and the camera-based light-sensitive lenticular material (291), thus reducing the required size of the camera body. The present camera can also utilize features found in conventional instant-developing-type cameras, including, for example, features that allow one or more mirrors to be raised and lowered to direct the exposure path to the camera's viewfinder (optical or electronic), to an auto-focusing device (prior to exposure), or to the light-sensitive lenticular material (during exposure). With both the mirrored and non-mirrored versions of this camera, parallax-adjustable embodiments can be produced. However, fixed-parallax models generally represent a simpler design and typically are less expensive to manufacture. With an adjustable-parallax camera, the lenses can be moved closer to, or farther apart from, each other to decrease or increase the amount of parallax between the individual images. Further, in the default mode the lenses remain equidistant to each other, but alternatively can be positioned where the distances between the lenses are not equal to each other.

The camera-based light-sensitive lenticular material used in a non-digital camera can employ various emulsion and photo-processing methods. For example, a “conventional” negative- or positive-based film or paper emulsion can be used, with the emulsion exposed through the lenticular layer and then processed thereafter with appropriate photochemical processing solutions. As with the printer-based light-sensitive lenticular material described herein, the camera-based light-sensitive lenticular material utilized in the non-digital camera can be sensitive to light visible to the human eye, and/or to light that is not visible to the human eye (e.g., non-visible electromagnetic radiation). Alternatively, instant-development emulsion and photo-processing technology can be used in the light-sensitive material. Instant autostereoscopic and non-stereoscopic hardcopies (both reflective prints and transparencies) can be produced and their sizes are determined by factors such as the available formats of the camera-based instant-developing light-sensitive lenticular material and the specific designs of the cameras used. The camera-based instant-developing light-sensitive lenticular material can utilize an instant-developing type of film back that contains rollers or another mechanism to rupture one or more pods that contain reagent fluid, which activates the instant-development process of the exposed instant-developing light-sensitive material. Alternatively, rollers or other mechanisms can be contained in the camera or in an instant-developing apparatus separate from the camera. Alternatively still, an instant-developing method can be utilized, where the reagent and developer photochemistry are coated on a separate sheet of material (rather than in one or more pods contained within the instant-developing light-sensitive material). Here, the sheet of material is pressed tightly for a period of time against the emulsion of the exposed instant-developing light-sensitive material in order to effect the instant-developing process.

As with the digital camera described herein, the non-digital camera can contain multiple shutters and diaphragms, with one of each positioned between each lens and the camera-based light-sensitive lenticular material. This camera can also utilize several features that are found in conventional 2D cameras, such as: programmable automatic exposure functions (with manual override), automatic focus functions (with manual override), variable shutter and manual time-lapse exposure functions, built-in and external flash functions, self-timer functions, and zoom and wide-angle lenses. All of the shutters of the non-digital camera can open and close simultaneously or, alternatively, the shutters can open individually and independently of each to record a series of images in succession via one or more of the lenses. This process allows an animation of images to be produced. With the non-digital camera, the opening and closing of each shutter can be pre-programmed by the user for the recording of timed or choreographed sequences, for time-lapse photography, or for remote operation. If the succession of images is acquired from one lens, and therefore only from one viewpoint, the resulting series typically represents a non-stereoscopic view. If the succession of images is acquired from more than one lens, and therefore from multiple viewpoints, the resulting series normally represents a stereoscopic view.

The digital and non-digital camera versions described herein can utilize lenses of a fixed focal length, or they can utilize zoom lenses. Fixed focal length lenses can provide for normal, telephoto, wide-angle, or macro viewing. With multiple-lens camera versions that utilize zoom lenses, the zoom factor or magnification of each lens can be set to adjust equally for all lenses on a camera as the camera zooms in or out. Alternatively, multiple zoom lenses on a camera can be set at different magnifications or zoom factors, which can be used to capture a series of images that can appear to zoom in or out as an animation effect exhibited by an autostereoscopic or non-stereoscopic animated hardcopy. Both the digital and non-digital cameras detailed herein can also utilize a panoramic format.

The digital and non-digital camera versions detailed herein also can include a digital image preview device, such as used in conventional digital cameras, video cameras, and non-digital cameras. This preview device can incorporate a conventional 2D type of display, such as an LCD monitor or, alternatively, can utilize an autostereoscopic display as the camera's preview device. If an autostereoscopic version of a preview device is used, the parallax determined by the difference in viewing angles between the camera's lenses can be represented stereoscopically in the camera's autostereoscopic monitor. Based on the view in the autostereoscopic monitor, the positioning in three-dimensional space of the scene's key image components and/or the distance between the lenses of the parallax-controllable camera versions can be adjusted prior to capturing the desired image content with the camera. This adjustment can control the amount of parallax present in the stereoscopic imagery captured by the camera, to create a desired stereopair or autostereoscopic hardcopy. The image data previewed on the camera's conventional or autostereoscopic monitor can also be recorded onto a digital image capture device that can be included in or with the camera. This recorded data can be used to print autostereoscopic or non-stereoscopic hardcopies or for any other use to which digital image data can be applied.

A version of the viewing angle calculation software described herein that can be utilized by the present printer can be included with, and used by any of, the present camera versions to facilitate the photographic capture of stereoscopic imagery exhibiting desired parallax, for the printing of autostereoscopic hardcopies, or for other stereoscopic imaging applications. For non-parallax-adjustable camera versions, the calculation software can be used to determine suggested distances between the camera and various components in the scene being photographed. For parallax-adjustable camera versions, in addition to calculating camera-to-subject distances, the software can be used to calculate distances between the camera's lenses, based on given or estimated camera-to-subject distances. With one or more parallax-adjustable camera versions using the software to calculate lens-to-lens distances, the required lens movements can be performed manually, while with other parallax-adjustable camera versions, the lenses can move automatically, driven by the results of the software's calculations.

Here, if <T> is given as the distance from the camera to the key subject point, <F> is the distance from the camera to the object in the scene closest to the camera, <B> is the distance from the camera to the object in the scene farthest from the camera (excluding a non-descript background, such as a blue sky), and <V> is a coefficient equal to 0.0011727 (assuming a camera lens' focal length is approximately equal to that of a 50 mm lens on a 35 mm camera), the distance <P> between the centers of two adjacent camera lenses can be calculated with the following equation:

$$( \frac{( T \times F )}{( T - F )} + \frac{( T \times B )}{( B - T )} ) \times V = P$$

The numerical value of the coefficient <V> can be increased or decreased according to variables including: type of stereoscopic imaging application (e.g., for hardcopy printing, for View-Master® reels, etc.), number of camera lenses, sizes of hardcopies to be printed (if any), focal length of lenses, or even subjective visual preference, in order to fine-tune the amount of desired parallax in the captured images. For example, for a camera with three lenses, the value for the coefficient <V> can be increased, compared to capturing an identical scene with a camera having five lenses, assuming all other variables were equal. Once <P> is known, using equivalent alternative forms of the equation used to calculate <P>, <P>, the value for either <T>, <F>, or <B> can be calculated if the value for the other two variables are known, in order to calculate the suggested camera-to-subject distances of key image components in the captured scene, for the printing of autostereoscopic hardcopies or for other stereoscopic imaging applications.

The photographic calculation software detailed herein also can be provided in a separate calculation device (such as a hand-held calculator, for example), for use with multiple-lens cameras absent the calculation software. The software can also be used independently for stereoscopic photography where a single-lens camera is moved to different horizontal positions with a track or other device, to capture a scene from different viewing perspectives, in which case the value <P> can designate the distance between the camera's adjacent positions along a straight line path. The software also can be used to plan stereoscopic photography sessions that may occur at some future time.

A lenticular print or transparency hardcopy created by the non-digital camera provides a viewer with the possibility of viewing many different types of images. For example, a stereoscopic 3D view of a scene is possible where a series of images are recorded of the same scene, from different viewpoints of the lenses. In the alternative, an animated image showing one scene or environment changing into another scene or environment is possible where each of the images recorded represents either a different scene or environment or the same scene or environment recorded over a period of time (rather than a different three-dimensional perspective of the same scene or environment).

With a 3D view, the lenticules are normally oriented vertically when the created autostereoscopic hardcopy is viewed. With a hardcopy exhibiting an animation, the lenticules can be oriented either vertically or horizontally. With an animation, the image appears to the viewer to change when the print or transparency is tilted along its axis parallel to the length of the lenticules, or when the viewer's viewing position changes in relation to the hardcopy. This orientation of the lenticules can be determined by the camera's orientation (i.e. either horizontal or vertical) when the images are captured. Another possibility exists whereby the lenticules are oriented vertically when viewed and a series of images of a scene can be recorded from different viewpoints and the scene also changes (animates) from one image to the next. The resulting hardcopy image presents to the viewer an autostereoscopic animated print or transparency and in this embodiment, the lenticules of the hardcopy are normally oriented along a vertical axis for viewing.

Applications

A complete system that includes any of the camera technologies described herein can be used to record and produce stereoscopic and non-stereoscopic images. The system can also include any of the previously described printer and light-sensitive lenticular material technologies to produce autostereoscopic and animated prints and transparencies. The system can include a series of printers, a series of digital and non-digital cameras, the use of instant-developing, conventional or non-conventional photo-processing technology for both the printer and non-digital cameras, and system software. The system's software can calculate viewing angles or camera lens positions, can process, convert and align images, can interface with multiple image sources, and can drive the printer or camera. An industry can be built around the creation of stereoscopic and non-stereoscopic images and the production of autostereoscopic and animated hardcopy prints and transparencies.

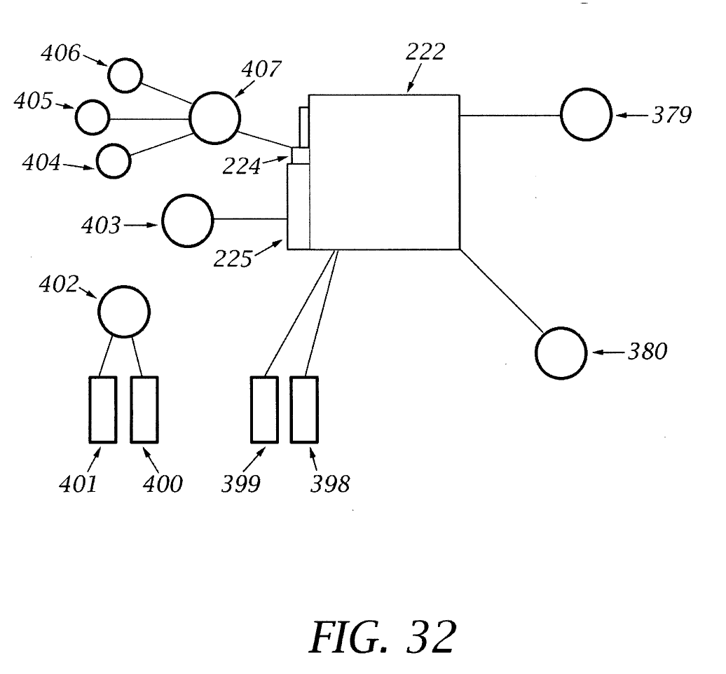

FIG. 32 shows several system components and example market applications related to the production and delivery of autostereoscopic and animated hardcopy prints and transparencies produced from digital and non-digital media. An automated printer (222) can use an electronic image capture device (224) to receive non-digital image content (407) from different media types. Examples of non-digital sources include film from non-digital cameras (404), stereopairs (405), and printed matter (406). The printer (222) can receive digital media from a computer (225) and/or other digital sources, including digital cameras (403). The printer (222) can receive image content (379) from many market applications related to medicine and science, including medical imaging, scientific visualization, drug design and molecular modeling, education, research and development, and other medical and scientific areas. The printer (222) can receive image content (380) from many applications not directly related to medicine and science, including security and defense, entertainment, military and government, design and engineering, oil and gas exploration, advertising and promotion, graphics and fine art, publishing and printing, transportation, consumer products, and other areas. The printer (222) can utilize printer-based light-sensitive lenticular material (398) and printer-based instant-developing light-sensitive material (399). Non-digital cameras (402) can utilize camera-based light-sensitive lenticular material (400) and camera-based instant-developing light-sensitive material (401).

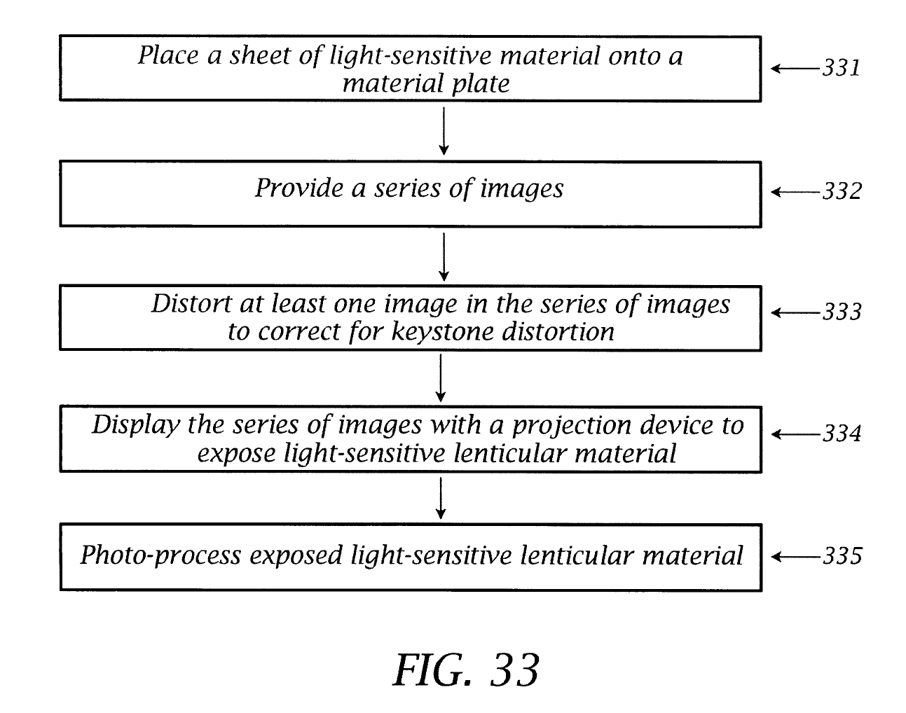

FIG. 33 shows a method of producing a hardcopy image, with the image being either autostereoscopic, animated, or autostereoscopic and animated. As shown in FIG. 33, the method for producing a hardcopy image includes in step 331 placing a sheet of light-sensitive lenticular material onto a material plate. The material plate being rotatable around two perpendicular axes. The light-sensitive lenticular material comprises a layer of lenticular material and a layer of light-sensitive material. The method further includes in step 332 providing a series of images, where each image in said series comprises a different image, and in step 333 distorting each image in the series to correct for keystone distortion. Each keystone distortion correction setting equaling a distinct rotation position of the material plate. The method further includes in step 334 displaying the series of images, including the at least one distorted image, with a projection device onto the light-sensitive lenticular material. The material plate then rotates to a different position as images are displayed to expose said light-sensitive lenticular material from different exposure angles. The method then includes in step 335 photo-processing exposed light-sensitive lenticular material. Other steps can be included with the method as detailed herein.

Many different input devices and applications can interface with the present printing and photography system. Applications and devices are being developed on a continuing basis, which further expands the number of possible uses of this system. Examples of possible input devices and application sources for the system include: medical imaging devices used to acquire data from many different imaging modalities, including ultrasound (still as well as animated or Doppler), magnetic resonance imaging (MRI), computed tomography (CT), angiography (static and rotational), nuclear medicine (including positron emission tomography [PET] and single photon emission computed tomography [SPECT]), multi-modality matching, bone density sampling devices, anatomical slice data (e.g., cryogenic devices), gamma knife surgery devices, chemotherapy devices (for treatment planning and analysis), laser scanners, and X-ray scanners; 3D graphics software programs; 3D modeling and rendering software; 3D design software; 3D engineering software; 3D computer aided design (CAD) software; 3D medical imaging software; oil and gas exploration or planning software; automobile and other vehicle design software; geographic information systems software; terrain mapping software; graphical data analysis software; landscape design software; architectural design software; interior and home design or layout software; environmental design software; lighting design software; audio system design software; stage design software; and fashion design software.

The present invention can also be used in with scientific imaging apparatuses (e.g., confocal microscopes, scanning and transmission electron microscopes, scanning tunneling microscopes, atomic force microscopes, scanning probe microscopes, lateral force microscopes, magnetic force microscopes, force modulation microscopes, chemical force microscopes, scanning acoustic microscopes, X-ray microtomographic microscopes, molecular MRI microscopes, stereo microscopes, binoculars, telescopes, and laparoscopes), satellite data (e.g., weather analysis, intelligence documentation and analysis, and measurement), radar data (e.g., volumetric coverage analysis, measurement and documentation, communication, and forensics), sonar data, and digital cameras (e.g., in the areas of entertainment, consumer products and services, portraiture, catalogues, fashion, fine art, and erotica). In addition, there are many different markets in which the commercial capabilities of the present system can be used.

The commercial capabilities of the present system can be used in medical markets for several applications, including: diagnostic imaging; surgical planning; multi-modality matching; doctor-to-patient communication; doctor-to-doctor communication; teaching and training; documentation and recordkeeping; treatment analysis and measurement; interventional radiology; radiological treatment and analysis (e.g., oncology); ophthalmology (e.g., glaucoma evaluation); cranio-facial (and other) reconstruction; cosmetic surgery planning; 3D Laser scanning; dentistry; veterinary imaging; research and development; keepsake ultrasound; whole body MRI imaging; and whole body CT imaging.

The commercial capabilities of the present system can be used in science markets for several applications, including: drug design and other molecular modeling (including interaction simulation); scientific visualization; geophysical sciences; genome research; grant applications; and documentation.

The commercial capabilities of the present system can be used in security markets for several applications, including: badges; labels; tickets; identification cards; 3D barcodes; 3D fingerprinting; facial recognition; retinal recognition; and stocks and bonds.

The commercial capabilities of the present system can be used in design markets for several applications, including: automotive design; parts design; aerospace design; transportation design; environmental design; audio design; stage design; lighting design; city planning; process design; and piping and electrical design.

The commercial capabilities of the present system can be used in military and law enforcement markets for several applications, including: data analysis; documentation; communication; and forensics.

The commercial capabilities of the present system can be used in consumer products markets for several applications, including: 3D and 2D digital cameras; 3D and 2D instant cameras; 3D and 2D animations; 3D and 2D video games; and 3D and 2D internet content.

The commercial capabilities of the present system can be used in entertainment markets for several applications, including: theme parks; virtual reality games; 3D and 2D internet games; video games; and movie clips (animated).

The commercial capabilities of the present system can be used in publishing markets for several applications involving both themed and non-themed content, including: magazine covers; magazine inserts; annual reports; book covers; textbooks; monographs; business cards; greeting cards; calendars; and trading cards.

The commercial capabilities of the present system can be used in advertising markets for several applications, including: magazine ads; covers for videos, DVDs (digital video discs), CDs (compact discs), video games, and software programs; trade show handouts; and pins and buttons.

The present invention utilizes integrated hardware and software to automate the process of producing autostereoscopic and animated hardcopies, so that the first copy of a light-sensitive lenticular material hardcopy can be produced by the push of a button, regardless of the format printed (horizontal, vertical, or square) or the type of media or source of the content (digital or non-digital).

An automated, integrated system with multiple components and sources available to record and produce stereoscopic and non-stereoscopic hardcopy imagery offers a significant commercial advantage over existing lenticular imaging systems. The ability to produce vertical or horizontal (or square) autostereoscopic or animated hardcopies from a large number of possible image sources allows a greater volume of light-sensitive lenticular material to be used by the system, thus potentially lowering the cost of the material and making the technology more attractive to end-uses. Further, the automated aspects of the system allow a first hardcopy to be produced quickly and of a high quality. Further still, the light-sensitive lenticular material technology provides consistent quality hardcopy output from the first hardcopy to subsequent hardcopies of the same stereoscopic or non-stereoscopic image content.

The present system can be made available in an automated kiosk-based configuration, with or without one or more of the present cameras, to facilitate user-friendly creation of stereoscopic and animated imagery and user-friendly production and delivery of autostereoscopic and animated hardcopies. The present system can also be utilized to offer automated stereoscopic and animated image creation services, as well as automated autostereoscopic and animated hardcopy production services, via an internet-based or brick-and-mortar business model. It is further possible to utilize the present system to digitally insert into a three-dimensional dataset or stereoscopic photographic image series two-dimensional or three-dimensional non-digital or digital image content of a person or object, and subsequently print and deliver an autostereoscopic hardcopy of the composite three-dimensional image, and this process can be offered via an automated kiosk configuration, or via an internet-based or brick-and-mortar business model.

With respect to the above description, it is to be realized that the optimum dimensional relationships for the parts of the invention, to include variations in size, materials, shape, form, function and manner of operation, assembly and use, are deemed readily apparent and obvious to one skilled in the art. All equivalent relationships to those illustrated in the drawings and described in the specification are intended to be encompassed by the present invention. Further, the various components of the embodiments of the present invention can be interchanged to produce further embodiments and these further embodiments are intended to be encompassed by the present invention. Various modifications can be made to the invention without departing from the scope thereof. Therefore, the foregoing is considered as illustrative only of the principles of the invention.

What is claimed is:

1. A printer for printing images onto lenticular material, said printer comprising:
a) a material plate capable of rotating around two perpendicular axes; and
b) a projection device.

2. The printer of claim 1, wherein said material plate rotates around the two perpendicular axes simultaneously.

3. The printer of claim 2, wherein said material plate rotates at an angle oblique to both said perpendicular axes.

4. The printer of claim 1, wherein the two perpendicular axes include a first axis and a second axis.

5. The printer of claim 1, wherein said material plate rotates between individual exposures of each image of said images.

6. The printer of claim 1, wherein said material plate rotates during individual exposures of each image of said images.

7. The printer of claim 1, wherein said projection device projects a color image.

8. The printer of claim 1, wherein said projection device projects a black-and-white image.

9. The printer of claim 1, wherein said projection device comprises a fixed matrix display.

10. The printer of claim 1, wherein said projection device comprises a CRT display.

11. The printer of claim 1, wherein said projection device comprises a laser display.

12. The printer of claim 1, wherein said projection device comprises a fiber-optic display.

13. The printer of claim 1, wherein said projection device comprises a square-formatted display.

14. The printer of claim 1, wherein said projection device comprises at least one lamp for illumination.

15. The printer of claim 1, wherein lens of said projection device is a fixed focal length lens.

16. The printer of claim 15, wherein said lens of said projection device comprises a normal, telephoto, wide-angle, or macro fixed focal length lens.

17. The printer of claim 1, wherein said projection device utilizes a turret with multiple lenses, said turret being positioned between said projection device and said material plate.

18. The printer of claim 17, wherein said multiple lenses comprise fixed focal length lenses.

19. The printer of claim 17, wherein said multiple lenses comprise zoom lenses.

20. The printer of claim 17, wherein said multiple lenses comprise at least one zoom lens and at least one fixed focal length lens.

21. The printer of claim 1, wherein lens of said projection device comprises a zoom lens.

22. The printer of claim 1, further comprising an internally located computer.

23. The printer of claim 1, further comprising an externally located computer.

24. The printer of claim 1, further comprising a computer located internal to said projection device.

25. The printer of claim 1, further comprising a color filter wheel positioned between said projection device and said material plate, wherein said color filter wheel comprises red, green, and blue filters.

26. The printer of claim 1, further comprising a color filter wheel positioned between said projection device and said material plate, wherein said color filter wheel comprises cyan, yellow, and magenta filters.

27. The printer of claim 1, further comprising a color filter wheel positioned between said projection device and said material plate, wherein said color filter wheel comprises red, green, blue, cyan, yellow, and magenta filters.

28. The printer of claim 1, further comprising a neutral density filter positioned between said projection device and said material plate.

29. The printer of claim 1, further comprising a mirror positioned between said projection device and said material plate.

30. The printer of claim 1, further comprising more than one mirror positioned between said projection device and said material plate.

31. The printer of claim 1, wherein lens of said projection device tilts to achieve Scheimpflug correction of an image of said images projected onto said material plate, and wherein said lens tilt is performed with motors.

32. The printer of claim 1, wherein lens of said projection device tilts to achieve Scheimpflug correction of an image of said images projected onto said material plate, and wherein said lens tilt is performed manually.

33. The printer of claim 1, further comprising an autostereoscopic monitor.

34. The printer of claim 1, wherein an image of said images becomes a hardcopy comprising light-sensitive lenticular material.

35. The printer of claim 34, wherein said hardcopy is printed at full resolution of said projection device in three formats: vertical, horizontal, and square.

36. The printer of claim 34, wherein said hardcopy is printed from both digital media and non-digital media.

37. The printer of claim 1, wherein an image of said images becomes an autostereoscopic print hardcopy.

38. The printer of claim 1, wherein an image of said images becomes an autostereoscopic transparency hardcopy.

39. The printer of claim 1, wherein an image of said images becomes an autostereoscopic print hardcopy that exhibits an animation effect.

40. The printer of claim 1, wherein an image of said images becomes a print hardcopy that exhibits an animation effect.

41. The printer of claim 1, wherein an image of said images becomes an autostereoscopic transparency hardcopy that exhibits an animation effect.

42. The printer of claim 1, wherein an image of said images becomes a transparency hardcopy that exhibits an animation effect.

43. The printer of claim 1, wherein an image of said images is printed at full resolution of said projection device in three formats: vertical, horizontal, and square.

44. The printer of claim 1, wherein said printer prints an image of said images from both digital media and non-digital media

45. The printer of claim 1, further comprising an image scanner.

46. The printer of claim 1, further comprising an electronic image capture device.

47. The printer of claim 1, further comprising an illumination device that projects said images aligned in registration with each other.

48. The printer of claim 1, wherein image of said images is pre-distorted to correct for keystone distortion.

49. The printer of claim 1, wherein image of said images is pre-distorted to correct for keystone distortion according to the rotated position of said material plate.

50. The printer of claim 1, further comprising software that controls said printer.

51. The printer of claim 1, further comprising software that pre-distorts an image of said images.

52. The printer of claim 1, further comprising software that aligns said images to each other for printing of autostereoscopic and animated hardcopies.

53. The printer of claim 1, further comprising software that controls said printer.

54. The printer of claim 1, further comprising software that aligns said images to each other for printing of autostereoscopic and animated hardcopies.

55. The printer of claim 1, further comprising software that calculates parameters for autostereoscopic printing from three-dimensional datasets.

56. The printer of claim 1, further comprising software that performs image processing functions for printing of autostereoscopic and animated hardcopies.

57. The printer of claim 1, further comprising software that creates intermediate angles between two stereopair images for printing of autostereoscopic hardcopies from a stereopair.

58. The printer of claim 1, further comprising software that converts a single two-dimensional image into a three-dimensional dataset for printing of autostereoscopic hardcopies.

59. The printer of claim 1, wherein said images are printed on light-sensitive lenticular material.

60. The printer of claim 1, wherein said images are printed on light-sensitive parallax barrier strip material.

61. The printer of claim 34, wherein said material plate includes a vacuum to flatly attach said light-sensitive lenticular material to said material plate during exposure.

62. The printer of claim 34, wherein said material plate includes a mechanical easel to flatly depose said light-sensitive lenticular material on said material plate during exposure.

63. The printer of claim 34, wherein said light-sensitive lenticular material is in sheet form.

64. The printer of claim 63, wherein more than one type of said light-sensitive lenticular material in said sheet form is loaded simultaneously into said printer.

65. The printer of claim 34, wherein said light-sensitive lenticular material is in roll form.

66. The printer of claim 65, wherein more than one type of said light-sensitive lenticular material in said roll form is loaded simultaneously into said printer.

67. The printer of claim 34, wherein said light-sensitive lenticular material is loaded into said printer in roll form and in sheet form simultaneously.

68. The printer of claim 65, wherein a specified length of said light-sensitive lenticular material is cut from a roll prior to exposure.

69. The printer of claim 34, wherein said light-sensitive lenticular material comprises a layer of instant-developing light-sensitive material.

70. The printer of claim 34, further comprising a photo-processor.

71. The printer of claim 1, further comprising a photo-processor.

72. A light-sensitive lenticular material comprising:
a lenticular layer and a layer of light-sensitive material;
wherein said layer of light-sensitive material has adhesive properties and is directly attached to said layer of light-sensitive material.

73. A light-sensitive lenticular material comprising:
a lenticular layer and a layer of light-sensitive material;
wherein said layer of light-sensitive material comprises an instant-developing material.

74. A light-sensitive lenticular material comprising:
a lenticular layer and a layer of light-sensitive material;
wherein said layer of light-sensitive material is optimized for use in a printer.

75. A light-sensitive lenticular material comprising:
a lenticular layer and a layer of light-sensitive material;
wherein said layer of light-sensitive material is optimized for use in a camera.

76. The light-sensitive lenticular material of claim 74, wherein said layer of light-sensitive material comprises an instant-developing material.

77. The light-sensitive lenticular material of claim 75, wherein said layer of light-sensitive material comprises an instant-developing material.

78. The light-sensitive lenticular material of claim 74, wherein said layer of light-sensitive material comprises a non-conventional photographic emulsion.

79. The light-sensitive lenticular material of claim 75, wherein said layer of light-sensitive material comprises a non-conventional photographic emulsion.

80. The light-sensitive lenticular material of claim 75, wherein said light-sensitive material has a specified range of spectral sensitivity.

81. The light-sensitive lenticular material of claim 75, wherein said light-sensitive material is sensitive to non-visible light.

82. The light-sensitive lenticular material of claim 73, further comprising at least one anti-halation layer.

83. The light-sensitive lenticular material of claim 74, further comprising at least one anti-halation layer.

84. The light-sensitive lenticular material of claim 75, further comprising at least one anti-halation layer.

85. The light-sensitive lenticular material of claim 73, further comprising an opaque layer on the side of said light-sensitive material opposite the lenticular layer.

86. The light-sensitive lenticular material of claim 74, further comprising an opaque layer on the side of said light-sensitive material opposite the lenticular layer.

87. The light-sensitive lenticular material of claim 75, further comprising an opaque layer on the side of said light-sensitive material opposite the lenticular layer.

88. A camera that can capture images from multiple viewpoints without moving said camera, comprising:
a) multiple lenses that can move laterally along a horizontal path;
b) a digital image recording medium; and
c) at least one memory storage device.

89. A camera that can capture images from multiple viewpoints without moving said camera, comprising:
a) a lens that can move laterally along a horizontal path;
b) a digital image recording medium; and
c) at least one memory storage devices.

90. A camera that can capture images from multiple viewpoints without moving said camera, comprising:
a) multiple lenses that can move laterally along a horizontal path;
b) multiple digital image recording media, wherein a digital image recording medium of said digital image recording media records a respective image from each lens of said multiple lenses; and
c) at least one memory storage devices.

91. The camera of claim 90, further comprising a shutter.

92. The camera of claim 90, further comprising multiple shutters.

93. The camera of claim 92, wherein said multiple shutters can open and close simultaneously.

94. The camera of claim 92, wherein each shutter of said multiple shutters can be programmed to open and close.

95. The camera of claim 90, further comprising at least one diaphragm.

96. The camera of claim 90, wherein said digital image recording media can capture moving images.

97. The camera of claim 90, wherein said digital image recording media can capture digital video.

98. The camera of claim 90, wherein said camera can record said images on photographic film.

99. The camera of claim 90, wherein each lens of said lenses is a fixed focal length normal, telephoto, wide-angle, or macro lens.

100. The camera of claim 90, wherein each lens of said lenses is a zoom lens.

101. The camera of claim 90, further comprising at least one mirror positioned between a lens of said lenses and a digital image recording medium of said digital image recording media.

102. The camera of claim 90, further comprising a digital image preview device.

103. The camera of claim 102, wherein said digital image preview device comprises an autostereoscopic monitor.

104. The camera of claim 90, wherein said digital image recording media can record in a panoramic format.

105. The camera of claim 90, wherein said lenses remain equidistant to each other.

106. The camera of claim 90, wherein said lenses are moved manually.

107. The camera of claim 89, wherein said lens is moved manually.

108. The camera of claim 90, wherein said lenses are moved by at least motor.

109. The camera of claim 89, wherein said lens is moved by at least one motor.

110. The camera of claim 90, further comprising software that can calculate lens positions and camera-to-subject distances for capturing stereoscopic images with said camera.

111. The camera of claim 90, further comprising software that can calculate lens positions and camera-to-subject distances for capturing stereoscopic images with said camera and can direct said motors to move said lenses.

112. A camera, comprising:
a) at least three lenses in a fixed position along a horizontal path;
b) multiple digital image recording media, wherein a digital image recording medium of said digital image recording media records a respective image from each lens of said at least three lenses; and
c) at least one memory storage device.

113. The camera of claim 112, further comprising a shutter.

114. The camera of claim 112, further comprising multiple shutters.

115. The camera of claim 114, wherein said shutters can be programmed to open and close.

116. The camera of claim 114, wherein said shutters can open and close simultaneously.

117. The camera of claim 112, further comprising at least one diaphragm.

118. The camera of claim 112, wherein said digital image recording media can record moving images.

119. The camera of claim 112, wherein said digital image recording media can record digital video.

120. The camera of claim 112, wherein said camera can record said images on photographic film.

121. The camera of claim 112, wherein each lens of said lenses is a fixed focal length normal, telephoto, wide-angle, or macro lens.

122. The camera of claim 112, wherein each lens of said lenses is a zoom lens.

123. The camera of claim 112, further comprising at least one mirror positioned between a lens of said lenses and a digital image recording medium of said digital image recording media.

124. The camera of claim 112, further comprising a digital image preview device.

125. The camera of claim 124, wherein said digital image preview device comprises an autostereoscopic monitor.

126. The camera of claim 112, wherein said digital image recording media can record in a panoramic format.

127. The camera of claim 112, further comprising software that can calculate camera-to-subject distances for capturing stereoscopic images with said camera.

128. A camera comprising:
multiple fixed-position lenses positioned equidistant to each other along a horizontal path;
wherein images from said lenses are aligned in registration with each other and focused onto a recording medium behind said lenses.

129. The camera of claim 128, wherein said recording medium comprises:
a) a digital image recording medium; and
b) at least one memory storage device.

130. The camera of claim 129, wherein said digital image recording medium can record in a panoramic format.

131. The camera of claim 129, wherein said digital image recording medium can record moving images.

132. The camera of claim 129, wherein said digital image recording medium can record digital video.

133. The camera of claim 128, wherein said recording medium comprises light-sensitive lenticular material, and said light-sensitive lenticular material comprises a lenticular layer and a layer of light-sensitive material.

134. The camera of claim 133, wherein said layer of light-sensitive material comprises an instant-developing material.

135. The camera of claim 133, wherein said layer of light-sensitive material is optimized for use in a camera.

136. The camera of claim 133, wherein said layer of light-sensitive material comprises a conventional photographic emulsion.

137. The camera of claim 133, wherein said layer of light-sensitive material comprises a non-conventional photographic emulsion.

138. The camera of claim 133, wherein said layer of light-sensitive material has a specified range of spectral sensitivity.

139. The camera of claim 133, wherein said layer of light-sensitive material is sensitive to non-visible light.

140. The camera of claim 128, wherein said lenses are not in a fixed-position, can move laterally along a horizontal path, and said images remain aligned in registration with each other and focused onto a recording medium behind said lenses.

141. The camera of claim 129, further comprising at least one mirror positioned between a lens of said lenses and said digital image recording medium.

142. The camera of claim 133, further comprising at least one mirror positioned between a lens of said lenses and said light-sensitive lenticular material.

143. The camera of claim 129, wherein each lens of said lenses is a fixed focal length normal, telephoto, wide-angle, or macro lens.

144. The camera of claim 133, wherein each lens of said lenses is a fixed focal length normal, telephoto, wide-angle, or macro lens.

145. The camera of claim 129, wherein each lens of said lenses is a zoom lens.

146. The camera of claim 133, wherein each lens of said lenses is a zoom lens.

147. The camera of claim 129, further comprising a digital image preview device.

148. The camera of claim 133, further comprising a digital image preview device.

149. The camera of claim 147, wherein said digital image preview device comprises an autostereoscopic monitor.

150. The camera of claim 148, wherein said digital image preview device comprises an autostereoscopic monitor.

151. The camera of claim 129, wherein said camera can record said images on photographic film.

152. The camera of claim 129, further comprising software that can calculate camera-to-subject distances for capturing stereoscopic images with said camera.

153. The camera of claim 133, further comprising software that can calculate camera-to-subject distances for capturing stereoscopic images with said camera.

154. The camera of claim 129, further comprising at least one diaphragm.

155. The camera of claim 133, further comprising at least one diaphragm.

156. The camera of claim 129, further comprising a shutter.

157. The camera of claim 133, further comprising a shutter.

158. The camera of claim 129, further comprising multiple shutters.

159. The camera of claim 133, further comprising multiple shutters.

160. The camera of claim 129, further comprising multiple shutters that can be programmed to open and close.

161. The camera of claim 133, further comprising multiple shutters that can be programmed to open and close.

162. The camera of claim 129, further comprising multiple shutters that can open or close simultaneously.

163. The camera of claim 133, further comprising multiple shutters that can open or close simultaneously.

164. A system for producing a hardcopy image, the system comprising:
a) a printer, comprising a material plate rotatable around two perpendicular axes;
b) light-sensitive lenticular material, comprising a layer of lenticular material and a layer of light-sensitive material; and
c) program components connected to and automating said printer.

165. The system of claim 164, wherein said image is autostereoscopic.

166. The system of claim 164, wherein said image exhibits an animation effect.

167. The system of claim 164, wherein said image is autostereoscopic and exhibits an animation effect.

168. The system of claim 164, further comprising a series of images.

169. The system of claim 164, further comprising a multiple-lens digital camera.

170. The system of claim 164, wherein said layer of light-sensitive material comprises an instant-developing material.

171. The system of claim 164, further comprising a multiple-lens non-digital camera.

172. The system of claim 164, wherein said layer of light-sensitive material comprises an instant-developing material.

173. A system for producing an autostereoscopic image comprising:
a) a non-digital multiple-lens camera; and
b) light-sensitive lenticular material, comprising a layer of lenticular material and a layer of light-sensitive material.

174. The system of claim 173, wherein said non-digital multiple-lens camera can record a series of images comprising multiple viewpoints of a three-dimensional object or scene on said light-sensitive lenticular material.

175. The system of claim 173, wherein said layer of light-sensitive material comprises an instant-developing material.

176. The system of claim 173, wherein said layer of light-sensitive material is sensitive to non-visible light.

177. A method for producing a hardcopy image, the method comprising:
a) placing a sheet of light-sensitive lenticular material onto a material plate, wherein said material plate is rotatable around two perpendicular axes, wherein said light-sensitive lenticular material comprises a layer of lenticular material and a layer of light-sensitive material;
b) providing a series of images, where each image in said series comprises a different image;
c) distorting at least one image in said series of images to correct for keystone distortion, where each keystone distortion correction setting equals a distinct rotation position of said material plate;
d) displaying said series of images, including the at least one distorted image, with a projection device onto said light-sensitive lenticular material; wherein said material plate rotates to a different position as images are displayed to expose said light-sensitive lenticular material from different exposure angles; and
e) photo-processing exposed light-sensitive lenticular material.

178. The method of claim 177, wherein said hardcopy image is autostereoscopic and each image in said series of images comprises a different viewpoint of a three-dimensional scene.

179. The method of claim 177, wherein said hardcopy image exhibits an animation effect.

180. The method of claim 177, wherein said hardcopy image is autostereoscopic, exhibits an animation effect, and each image in said series of images comprises a different viewpoint of a three-dimensional scene.

181. The method of claim 177, wherein lenticules of said layer of lenticular material are oriented parallel to an axis of rotation of said material plate.

182. The method of claim 177, wherein said layer of light-sensitive material comprises an instant-developing material.

183. The method of claim 177, further comprising pre-aligning said each image in said series of images before printing.

184. The method of claim 177, further comprising using wireless data transmission to convey said series of images to said projection device.

185. The method of claim 177, further comprising using a network to convey said series of images to said projection device.

186. The method of claim 177, further comprising:
recording a non-digital series of images with an image scanner.

187. The method of claim 177, further comprising:
recording a non-digital series of images with an electronic image recording device.

188. The method of claim 177, further comprising pre-viewing said series of images on an autostereoscopic monitor.

189. The method of claim 177 further comprising image-processing said series of images prior to exposing said light-sensitive lenticular material.

190. A method of recording stereoscopic photographic images, comprising:
capturing images from multiple horizontally-displaced viewpoints with a multiple-lens camera comprising at least one digital image recording device.

191. A method of recording stereoscopic photographic images, comprising:
capturing images from multiple horizontally-displaced viewpoints with a multiple-lens camera onto light-sensitive lenticular material.

192. The method of claim 190, wherein said multiple-lens camera is positioned to take aerial views of a three-dimensional scene.

193. The method of claim 191, wherein said multiple-lens camera is positioned to take aerial views of a three-dimensional scene.

194. The method of claim 191, wherein said multiple-lens camera is loaded with said light-sensitive lenticular material comprising said layer of light-sensitive material that is sensitive to infrared light.

195. The method of claim 191, wherein said multiple-lens camera is loaded with said light-sensitive lenticular material comprising said layer of light-sensitive material that is sensitive to radar.

196. The method of claim 191, wherein said multiple-lens camera is loaded with said light-sensitive lenticular material comprising said layer of light-sensitive material that is sensitive to sonar.

197. The method of claim 191, wherein said multiple-lens camera is loaded with said light-sensitive lenticular material comprising said layer of light-sensitive material that is sensitive to x-rays.

198. A hardcopy image formed by a method comprising:
a) placing a sheet of light-sensitive lenticular material onto a material plate, wherein said material plate is rotatable around two perpendicular axes, wherein said light-sensitive lenticular material comprises a layer of lenticular material and a layer of light-sensitive material;
b) providing a series of images, with each image in said series of images comprising a different viewpoint of a three-dimensional scene;
c) distorting at least one image in said series of images to correct for keystone distortion, where each keystone distortion correction setting equals a distinct rotation position of said material plate;
d) displaying said series of images, including the at least one distorted image, with a projection device onto said light-sensitive lenticular material; wherein said material plate rotates to a different position as images are displayed to expose said light-sensitive lenticular material from different exposure angles; and
e) photo-processing exposed light-sensitive lenticular material.

199. The image formed by the method of claim 198, wherein the image is an autostereoscopic hardcopy.

200. The image formed by the method of claim 198, wherein the image is a hardcopy with an animation effect.

201. The image formed by the method of claim 198, wherein the image is an autostereoscopic hardcopy with an animation effect.
